(19) United States
(12) Patent Application Publication
(10) Pub. No.: US 2025/0202731 A1
(43) Pub. Date: Jun. 19, 2025

(54) FAULT-MANAGED POWER FOR DISTRIBUTED DRIVES

(71) Applicant: Rockwell Automation Technologies, Inc., Mayfield Heights, OH (US)

(72) Inventors: Scott Griffiths, Port Washington, WI (US); Jon Vanderpas, Appleton, WI (US); Arun Guru, Mequon, WI (US); Michael Cook, Mequon, WI (US); Robert Schmidt, Germantown, WI (US); David D. Brandt, New Berlin, WI (US)

(21) Appl. No.: 18/389,593

(22) Filed: Dec. 19, 2023

(51) Int. Cl. H04L 12/40; H04L 12/10; H04L 67/12

(52) U.S. Cl. CPC H04L 12/40013; H04L 12/10; H04L 12/40039; H04L 67/12

(57) ABSTRACT

The present technology relates to fault-managed power (FMP), and particularly, to generating FMP in an industrial automation environment using single-pair Ethernet (SPE) cabling for use by DC motors. An FMP system may include transmitter circuitry and receiver circuits coupled together via a transmission link formed using SPE cable. The transmitter circuitry can generate a FMP and transmit a pulsed signal having the FMP to the receiver circuits. The transmitter circuitry can also exchange data signals with the receiver circuits over a communication channel using the SPE cable. The receiver circuits can identify an expected power consumption of DC motors coupled to the receiver circuits and provide an indication of the expected power consumption to the transmitter circuitry. The transmitter circuitry can detect a fault based on a comparison between the transmitted FMP and the power consumption and terminate transmission of the FMP in response to detecting the fault.

### RELATED APPLICATIONS

This application is related to U.S. patent application filed under Attorney Docket No. 2023P-107-US, titled “FAULT-MANAGED POWER VIA BLACK-CHANNEL SAFETY PROTOCOL”, filed concurrently with this application and U.S. patent application filed under Docket No. 2023P-156-US, titled “DC MOTOR DRIVEN BY CLASS 4 FAULT-MANAGED POWER INTEGRATED INTO A LOW-VOLTAGE DRIVE”, filed concurrently with this application, which are both hereby incorporated by reference in their entirety.

### TECHNICAL FIELD

Various embodiments of the present technology relate to fault-managed power, and particularly, to generating fault-managed power in an industrial automation environment.

### BACKGROUND

Fault-managed power is a class of commercial power under the National Electric Code (NEC) in the United States that includes the use of a transmitter and a receiver to transfer power over low-voltage cable and monitor such power for faults that may cause harm to people, structures, or devices. Fault-managed power falls under Class 4 power and therefore can only include a transmission of 450 V or less. Further requirements under the NEC related to Class 4 power require a fault-managed power transmitter to detect various types of faults, including short-circuits, line-to-line faults, line-to-ground faults, overcurrent, malfunction in monitoring components, and any other condition that may cause fire or shock.

Various fault-managed power solutions exist today to convert and transfer grid power over low-voltage cabling. For example, one fault-managed power solution provides pulsed fault-managed power to a receiver. When the transmission of power is “on,” the receiver receives the fault-managed power. When the transmission of power is “off,” the transmitter does not send power, but rather, the receiver communicates signals back to the transmitter related to power consumption of the fault-managed power. In another example, a transmitter sends fault-managed power over a transmission line to a receiver. The receiver, however, does not communicate back to the transmitter using the same transmission line. Rather, the receiver and transmitter communicate with each other using a mesh network.

### SUMMARY

Systems, devices, and methods are provided herein for generating fault-managed power transmittable from a transmitter to a receiver as an unpulsed signal using single-pair Ethernet cabling. An industrial or commercial environment may include various industrial automation devices, such as variable-speed drives, motors, and the like, that perform industrial automation processes. Such devices require power to perform industrial or automation operations, however, traditional power delivered to these devices may be limited with respect to safety and voltage. Rather, fault-managed power, or class 4 power, can provide higher voltages to industrial devices using cost-effective and longer, flexible cables with built-in safety mechanisms to detect line-to-line and line-to-ground faults, among other types of faults. The fault-managed power can be monitored by both the transmitter and the receiver to determine whether loads, or the industrial devices, are receiving acceptable amounts of power required for specific operations.

In an embodiment of the present technology, a system for producing fault-managed power, driving distributed drives with the fault-managed power, and detecting faults within the fault-managed power system and distributed drives is provided. A fault-managed power system may include a first power supply, a second power supply, a power interface module, and drive receiver circuitry. The first power supply is configured to generate a first power. The second power supply is coupled to receive the first power from the first power supply. The second power supply includes bus transmitter circuitry configured to generate a fault-managed control power based on the first power and transmit the fault-managed control power to a power interface module via a first transmission link formed using a first single-pair Ethernet cable. The power interface module is coupled to receive the first power from the first power supply and includes module receiver circuitry and module transmitter circuitry. The module receiver circuitry is configured to receive the fault-managed power from the second power supply. The module transmitter circuitry is configured to generate a fault-managed power based on the first power from the first power supply, transmit an unpulsed signal comprising the fault-managed power to the drive receiver circuitry via a second transmission link formed using a second single-pair Ethernet cable, establish a continuous communication channel with the drive receiver circuitry using the second single-pair Ethernet cable for exchanging data signals, receive an indication of load power consumption from the drive receiver circuitry via the continuous communication channel, detect a fault based on a comparison between the transmitted fault-managed power and the load power consumption, and terminate, in response to detecting the fault, transmission of the fault-managed power to the drive receiver circuitry. The drive circuitry is coupled to the module transmitter circuitry via the second single-pair Ethernet cable and to two or more distributed drives in an industrial automation environment. Each of the two or more distributed drives is configured to drive a respective motor using the fault-managed power.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

While multiple embodiments are disclosed, still other embodiments of the present technology will become apparent to those skilled in the art from the following detailed description, which shows and describes illustrative embodiments of the invention. As will be realized, the technology is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIGS. 1A, 1B, 1C, and 1D illustrate example operating environments in accordance with some embodiments of the present technology.

FIG. 2 illustrates an example block diagram of a fault-managed power system in accordance with some embodiments of the present technology.

FIG. 3 illustrates an example block diagram of components of a fault-managed power system in accordance with some embodiments of the present technology.

FIG. 4 illustrates an example block diagram of components of a fault-managed power system in accordance with some embodiments of the present technology.

FIG. 5 illustrates example devices that may be used to connect components of a fault-managed power system in accordance with some embodiments of the present technology.

FIG. 6 illustrates an example block diagram of components of a fault-managed power system in accordance with some embodiments of the present technology.

FIG. 7 illustrates an example operating environment in accordance with some embodiments of the present technology.

FIG. 8 illustrates a series of steps for detecting faults within a fault-managed power system in accordance with some embodiments of the present technology.

FIG. 9 illustrates an example computing system used in some embodiments of the present technology.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology relate to producing and transmitting fault-managed power for use in an industrial automation environment, and more particularly, to providing unpulsed power from a transmitter to a receiver using single-pair Ethernet cabling for operation of one or more distributed drives. In an industrial or commercial environment, industrial automation devices, such as variable-speed drives, distributed drives, large servos, motors, and the like, perform industrial automation processes and require power to perform such processes. Installation of traditional power systems requires professional installation and safety checks to ensure that AC mains electricity is properly driven to the devices and systems in an environment. Such power systems often limit the distance between the power source and the load (e.g., a DC motor) due to some intolerance to voltage drops in cabling. Further, such cabling generally requires conduit and specific installation to prevent harm to other people or equipment. Despite this safety restriction, Class 1 power does not require line-to-line fault protection to be monitored.

To address these issues, a fault-managed power system can employ a transmitter, one or more receivers, and low-voltage cabling, such as would be used for single-pair Ethernet (SPE), to generate fault-managed power for use by one or more distributed drives (e.g., distributed-servo drive, distributed-servo motor) and components thereof. Fault-managed power (FMP) is classified as Class 4 power under the NEC. It requires fault-detection of line-to-line faults, among other types of faults. The fault-managed power can be generated from AC mains power, or from DC power, and transmitted across the SPE cabling continuously. The receiver(s) can use the fault-managed power to drive one or more drives operating in an industrial automation environment. By using FMP, conduit and other heavy-duty protection mechanisms can be avoided. Rather, FMP cabling can be installed in cable trays and raceways along with other data cables to reduce installation costs. In addition to power being transmitted via FMP, data and communications can be provided between the transmitter and receivers continuously via SPE to allow the transmitter to detect various faults at speeds in accordance with safety protocols.

In an embodiment of the present technology, a system for producing fault-managed power, driving distributed drives with the fault-managed power, and detecting faults within the fault-managed power system and the distributed drives is provided. A fault-managed power system may include a first power supply, a second power supply, a power interface module, and drive receiver circuitry. The first power supply is configured to generate a first power. The second power supply is coupled to receive the first power from the first power supply. The second power supply includes bus transmitter circuitry configured to generate a fault-managed control power based on the first power and transmit the fault-managed control power to a power interface module via a first transmission link formed using a first single-pair Ethernet cable. The power interface module is coupled to receive the first power from the first power supply and includes module receiver circuitry and module transmitter circuitry. The module receiver circuitry is configured to receive the fault-managed power from the second power supply. The module transmitter circuitry is configured to generate a fault-managed power based on the first power from the first power supply, transmit an unpulsed signal comprising the fault-managed power to the drive receiver circuitry via a second transmission link formed using a second single-pair Ethernet cable, establish a continuous communication channel with the drive receiver circuitry using the second single-pair Ethernet cable for exchanging data signals, receive an indication of load power consumption from the drive receiver circuitry via the continuous communication channel, detect a fault based on a comparison between the transmitted fault-managed power and the load power consumption, and terminate, in response to detecting the fault, transmission of the fault-managed power to the drive receiver circuitry. The drive circuitry is coupled to the module transmitter circuitry via the second single-pair Ethernet cable and to two or more distributed drives in an industrial automation environment. Each of the two or more distributed drives is configured to drive a respective motor using the fault-managed power.

In another embodiment, a fault-managed power system including a transmitter circuit and two or more receiver circuits may be provided. The transmitter circuitry of the fault-managed power system is coupled to receive power from a power source. The transmitter circuitry configured to generate a fault-managed power based on the power from the power source, transmit an unpulsed signal comprising the fault-managed power to the two or more receiver circuits via a transmission link formed using a single-pair Ethernet cable, establish a continuous communication channel with the two or more receiver circuits using the single-pair Ethernet cable for exchanging data signals, receive an indication of power consumption from the two or more receiver circuits via the continuous communication channel, detect a fault based on a comparison between the transmitted fault-managed power and the power consumption, and terminate, in response to detecting the fault, transmission of the fault-managed power to the two or more receiver circuits. Each of the two or more receiver circuits is coupled to the transmitter circuitry via the single-pair Ethernet cable and to a distributed drive in an industrial automation environment. Each of the distributed drives is configured to drive a respective motor using the fault-managed power.

In yet another another embodiment, a fault-managed power system is provided that includes a first power supply, a second power supply, and a power interface module. The first power supply is configured to generate a first power. The second power supply is coupled to receive the first power from the first power supply. The second power supply includes transmitter circuitry configured to generate a fault-managed control power based on the first power from the power source, transmit the fault-managed control power to the power interface module via a transmission link formed using a single-pair Ethernet cable, establish a continuous communication channel with the receiver circuitry of the power interface module using the single-pair Ethernet cable for exchanging data signals, receive an indication of control power consumption from the receiver circuitry via the continuous communication channel, detect a fault based on a comparison between the transmitted fault-managed control power and the control power consumption, and terminate, in response to detecting the fault, transmission of the fault-managed control power to the receiver circuitry. The power interface module is coupled to receive the first power from the first power supply, and the receiver circuitry of the power interface module is configured to receive the fault-managed control power from the second power supply.

Advantageously, the disclosed system can provide uninterrupted, high-voltage fault-managed power, including both primary power and control power, to power distributed drives, accompanying motors, and other components thereof (e.g., blowers, heaters, brakes) and initialization of such components, operating in an industrial or commercial environment, for example, while maintaining fire and shock safety. The system can use sets of single-pair Ethernet (SPE) cabling to transmit unpulsed power signals that may provide continuous power to distributed drives while also allowing continuous transmission of data and communications that can ride over the power transmitted through the SPE. The system can operate in accordance with one or more safety communications protocols, such that the transmission of data and communications can occur within threshold time frames to prevent fire, shock, or other risk if a fault is detected in one or more of the receiver circuits, respective motors, or elsewhere in the system. Not only does the fault-managed power system improve device and system performance in an industrial automation environment, but also it can reduce installation cost and risk and increase control over power to individual drives and motors and receivers by providing the ability to terminate transmission of the fault-managed power at the receiver or line level. Further, fault-managed control power may reduce power architectures of distributed drives, large servos, or other devices as the fault-managed control power can provide increased amounts of voltage to components of the drives or servos that may otherwise need to be powered using external power supplies.

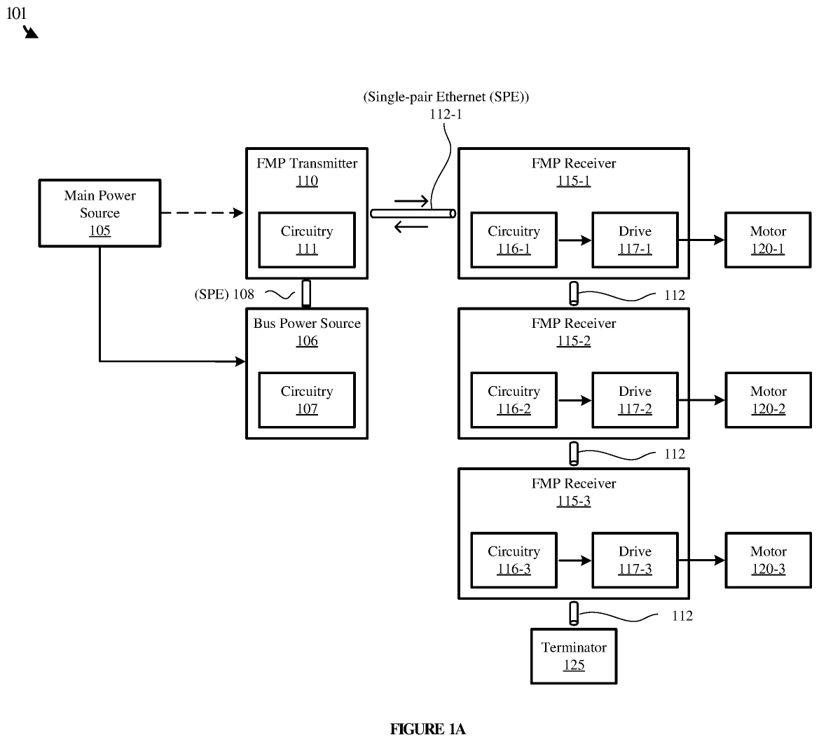

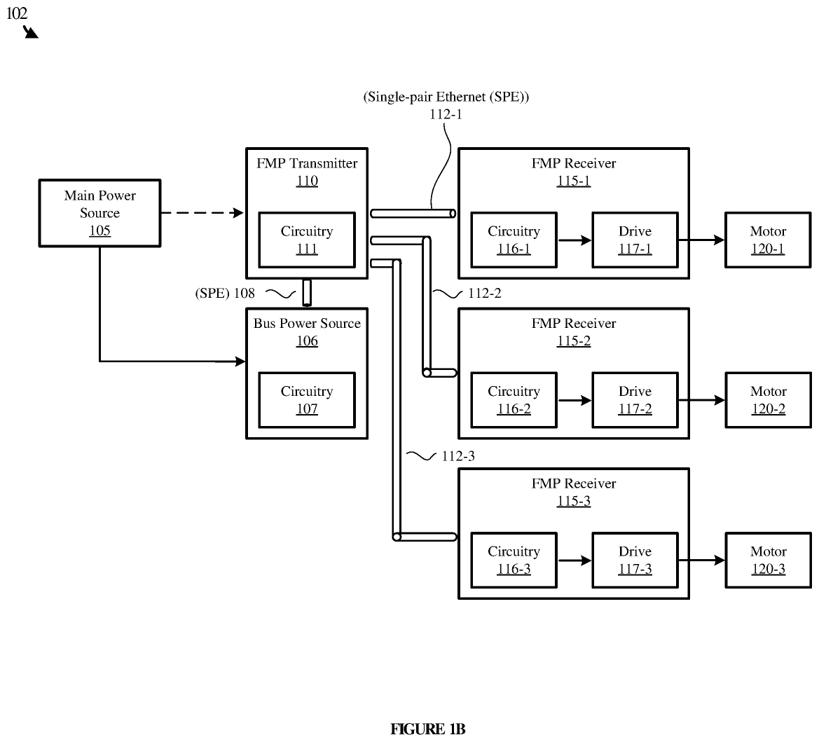

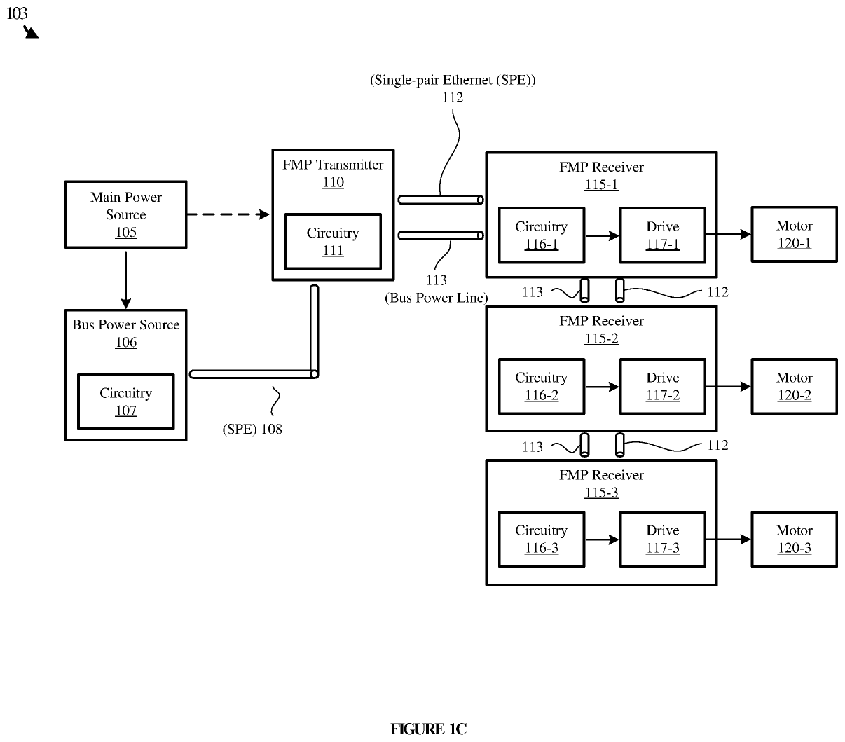

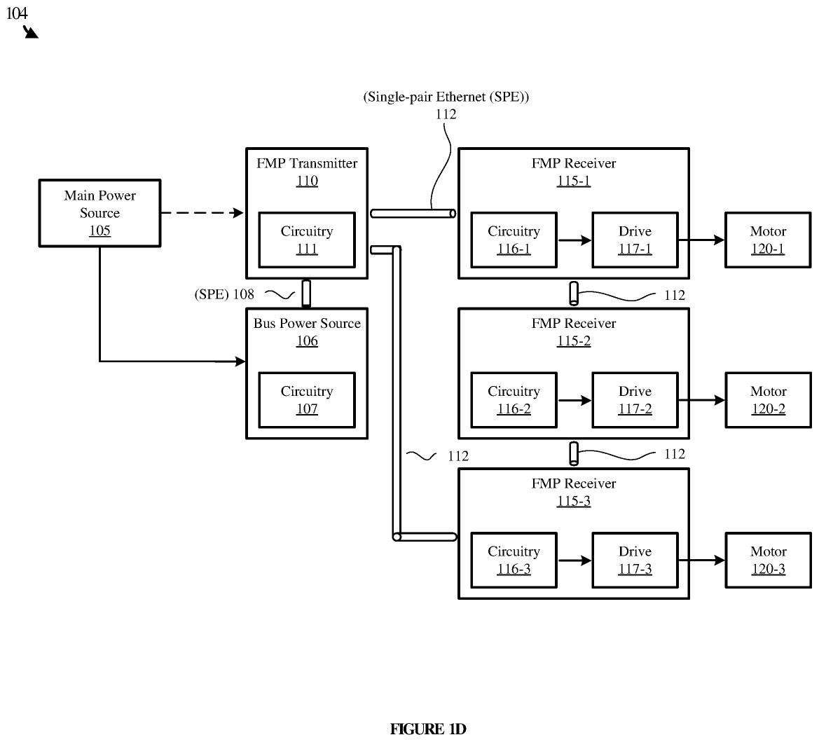

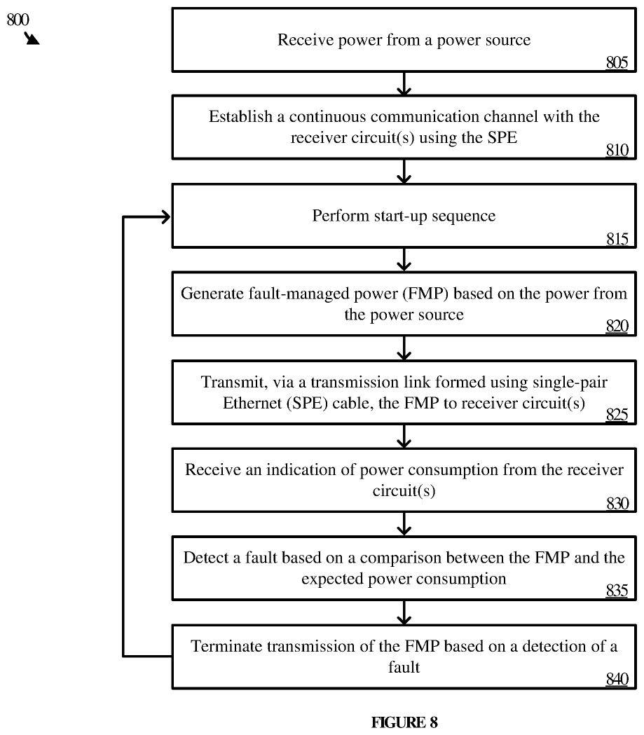

Turning now to the Figures, FIGS. 1A, 1B, 1C, and 1D illustrate example operating environments in accordance with some embodiments of the present technology. FIG. 1A includes operating environment 101, which is representative of an environment in which industrial and commercial processes may be performed, and in which power can be converted from one form of power to fault-managed power for transmission over a transmission line for use by devices in the environment. Operating environment 101 includes main power source 105, bus power source 106, fault-managed power (FMP) FMP transmitter 110, FMP receivers 115-1, 115-2, and 115-3 (collectively FMP receivers 115), motors 120-1, 120-2, and 120-3, and terminator 125 arranged in a multi-drop topology. Bus power source 106 further includes circuitry 107, FMP transmitter 110 further includes circuitry 111, FMP receivers 115-1 further includes circuitry 116-1 and drive 117-1, FMP receivers 115-2 further includes circuitry 116-2 and drive 117-2, and FMP receivers 115-3 further includes circuitry 116-3 and drive 117-3. In various examples, FMP transmitter 110 may be configured to perform fault-managed power processes, such as process 800 of FIG. 8. FIG. 1B includes operating environment 102, which is also representative of an environment in which industrial and commercial processes may be performed, and in which power can be converted from one form of power to fault-managed power for transmission over a transmission line for use by devices in the environment. Operating environment 102 includes the same elements as operating environment 101, however, communications and power transmission between FMP transmitter 110 and FMP receivers 115 may be arranged in a star topology. FIG. 1C includes operating environment 103, which is also representative of an environment in which industrial and commercial processes may be performed, and in which power can be converted from one form of power to fault-managed power for transmission over a transmission line for use by devices in the environment. Operating environment 103 includes the same elements as operating environments 101 and 102, however, communications may be provided to FMP receivers 115 via SPE 112 and power may be provided to FMP receivers 115 via bus power line 113. FIG. 1D includes operating environment 104, which is also representative of an environment in which industrial and commercial processes may be performed, and in which power can be converted from one form of power to fault-managed power for transmission over a transmission line for use by devices in the environment. Operating environment 104 includes the same elements as operating environments 101, 102, and 103, however, FMP transmitter 110 and FMP receivers 115 may be arranged in a ring topology whereby FMP transmitter 110 is also directly connected to FMP receiver 115-3 via SPE 112.

Referring first to FIG. 1A, operating environment 101 represents an industrial automation, industrial, or commercial environment where a first fault-managed power may be generated and transmitted from FMP transmitter 110 to FMP receivers 115 to drive industrial and industrial automation devices (e.g., drives 117, motors 120) and a second fault-managed power, such as a control power, may be generated and transmitted from bus power source 106 to FMP transmitter 110, and optionally downstream to FMP receivers 115. In some examples, both of the fault-managed powers may be generated by and transmitted to respective components, however, in other examples, only one of the fault-managed powers may be generated by and transmitted to respective components.

Main power source 105 is representative of any alternating current (AC) or direct current (DC) power source. For example, main power source 105 may be AC mains electricity or a DC source, such as a rectifier or fuel cell. In some examples, main power source 105 may produce power categorized under Class 1 or Class 2 power of the NEC. Main power source 105 may be coupled to bus power source 106, or circuitry 107 of bus power source 106, to provide power to bus power source 106. In some cases, main power source 105 may additionally, or instead, be coupled to FMP transmitter 110, or circuitry 111 of FMP transmitter 110, to provide power to FMP transmitter 110.

Bus power source 106 is representative of a DC power source, such as a DC bus, that can convert the power provided by main power source 105 and provide power toto FMP transmitter 110, among other components of a system. In various examples, bus power source 106 may generate a DC power for driving FMP transmitter 110. Bus power source 106 may further be configured to generate a DC control power, in the form of fault-managed power, for FMP transmitter 110. The fault-managed control power may fall under Class 4 power. Accordingly, bus power source 106 may include circuitry 107 to generate both the DC bus power and the fault-managed DC control power and provide both to FMP transmitter 110. In other examples, an external power source (not shown) may generate the DC control power and provide the control power to bus power source 106 for transmission downstream to FMP transmitter 110.

Circuitry 107 is representative of various electronic and electro-mechanical elements capable of interfacing with main power source 105, converting the power from main power source 105 to DC power, generating a main DC power, a fault-managed control power, and transmitting the fault-managed control power, the main DC power, and communications to FMP transmitter 110 (i.e., transmitter circuitry). In various examples, circuitry 107 may include a microcontroller, one or more power converters, transformers, diodes, resistors, capacitors, and the like. The microcontroller may include one or more processors or processing units capable of communicating with FMP transmitter 110, transmitting data and power to FMP transmitter 110, and detecting a fault within bus power source 106 or FMP transmitter 110 during transmission of the fault-managed control power. Examples of such processor(s) may include microcontrollers, DSPs, general purpose central processing units, application specific processors or circuits (e.g., ASICs), and logic devices (e.g., FPGAs), as well as any other type of processing device, combinations, or variations thereof.

FMP transmitter 110 is representative of a device, apparatus, or circuitry capable of receiving power (e.g., DC bus power, fault-managed control power) from bus power source 106 via a first transmission line or link (single-pair Ethernet (SPE) 108), receiving the main power from main power source 105 (optionally), generating fault-managed power based on the power received from either main power source 105 or bus power source 106, and providing both the fault-managed power and the fault-managed control power (from bus power source 106) to FMP receivers 115 over a second transmission line or link (SPE 112). FMP transmitter 110 may further be capable of establishing a continuous communication channel with both bus power source 106 and FMP receivers 115 via the transmission lines for exchanging data signals between FMP transmitter 110 and bus power source 106 and FMP transmitter 110 and FMP receivers 115. To perform power conversion, power transmission, and communications, FMP transmitter 110 may include circuitry 111.

Circuitry 111 is representative of various electronic and electro-mechanical elements capable of interfacing with main power source 105, bus power source 106, and FMP receivers 115, and transmitting and receiving fault-managed powers and communications between bus power source 106 and FMP receivers 115. In other words, circuitry 111 may include elements representative of both transmitter circuitry and receiver circuitry. In various examples, circuitry 111 may include a microcontroller, one or more power converters, transformers, diodes, resistors, capacitors, and the like. The microcontroller may include one or more processors or processing units capable of communicating with FMP receivers 115, transmitting data and power to FMP receivers 115, and detecting a fault within FMP transmitter 110 or FMP receivers 115 during transmission of the fault-managed power. Examples of such processor(s) may include microcontrollers, DSPs, general purpose central processing units, application specific processors or circuits (e.g., ASICs), and logic devices (e.g., FPGAs), as well as any other type of processing device, combinations, or variations thereof.

FMP transmitter 110 and bus power source 106 are coupled via a transmission link formed using SPE 108. Similarly, FMP transmitter 110 and FMP receivers 115 are coupled via a transmission link formed using SPE 112. SPE 108 and SPE 112 may each include a pair of conductors (i.e., wires). The pairs of conductors may be used to transmit fault-managed power from bus power source 106 to FMP transmitter 110 and from FMP transmitter 110 to FMP receivers 115. The pairs of conductors may further be used to exchange communications between FMP transmitter 110 and bus power source 106 and FMP transmitter 110 and FMP receivers 115.

In various examples, bus power source 106 provides the fault-managed control power to FMP transmitter 110 over SPE 108 as an unpulsed signal, and FMP transmitter 110 provides the fault-managed control power and fault-managed power to FMP receivers 115 over SPE 112 as unpulsed signals. In other words, the signals may have a duty cycle of 100%, thus, the fault-managed control power is provided to FMP transmitter 110 and the fault-managed power is provided to FMP receivers 115 continuously. In examples where bus power source 106 generates fault-managed control power for use by FMP transmitter 110, bus power source 106 may also establish a first continuous communication channel with FMP transmitter 110 using SPE 108. Regardless of whether bus power source 106 generates the fault-managed control power or not, FMP transmitter 110 may establish a second continuous communication channel with FMP receivers 115 using SPE 112. Communications and data transmitted between the components in operating environment 101 can ride directly over the fault-managed control power and fault-managed power continuously, allowing bus power source 106 and FMP transmitter 110 to detect faults during transmission and reception of the fault-managed powers.

FMP receivers 115 are representative of devices, apparatuses, or circuitry capable of receiving power from FMP transmitter 110, converting the power into power usable by drives 117, and providing an expected power consumption by drives 117 to FMP transmitter 110 over a continuous communication channel via SPE 112 (e.g., power interface modules (PIMs), single-axis inverters, dual-axis inverters). As shown in operating environment 101, FMP receivers 115 may be coupled with FMP transmitter 110, via SPE 112, in a multi-drop topology. In other words, FMP receivers 115-1 may be coupled directly with FMP transmitter 110, FMP receivers 115-2 may be coupled with FMP receivers 115-1, and FMP receivers 115-3 may be coupled with FMP receivers 115-2. Fault-managed power and communications may flow through a single path from FMP transmitter 110 to FMP receivers 115-1 to FMP receivers 115-2 and to FMP receivers 115-3 and back to FMP transmitter 110. Terminator 125, representative of an electrical termination circuit for matching impedance of the fault-managed power and reducing cable losses, may also be included at the end of SPE 112, or coupled to FMP receivers 115-3. In this topology, if a fault is detected in any one of FMP receivers 115 or FMP transmitter 110, transmission of fault-managed power may be terminated such that none of FMP receivers 115 receive the fault-managed power.

If there are no faults in the fault-managed power system, FMP receivers 115 can receive the fault-managed power and provide the power to drives 117. In some examples, FMP receivers 115 may convert the fault-managed power to a different power (e.g., from DC to AC, from DC to DC) before providing the power to drives 117. To perform power conversion and transmission to drives 117 and to communicate with FMP transmitter 110 via the continuous communication channel, FMP receivers 115 may each include circuitry 116. More specifically, FMP receivers 115-1 includes circuitry 116-1 coupled to drive 117-1, FMP receivers 115-2 includes circuitry 116-2 coupled to drive 117-2, and FMP receivers 115-3 includes circuitry 116-3 coupled to drive 117-3.

Circuitry 116 is representative of various electronic and electro-mechanical elements capable of interfacing with FMP transmitter 110 and drives 117, converting the fault-managed power to power appropriate for each of drives 117, and communicating expected power consumption by drives 117 to FMP transmitter 110. In various examples, circuitry 116-1, 116-2, and 116-3 may each include a microcontroller, one or more power converters, transformers, diodes, resistors, capacitors, and the like. The microcontrollers may include one or more processors or processing units capable of communicating with FMP transmitter 110 and transmitting data to FMP transmitter 110 during operation. Examples of such processor(s) may include microcontrollers, DSPs, general purpose central processing units, application specific processors or circuits (e.g., ASICs), and logic devices (e.g., FPGAs), as well as any other type of processing device, combinations, or variations thereof.

Drives 117 are representative of any type of distributed drives operating in an industrial, commercial, industrial automation, or similar environment. Examples of drives 117 may include distributed-servo motors (DSMs), distributed-servo drives (DSDs), or the like. In various examples, drives 117 may include circuitry configured to convert the fault-managed power into a power usable by motors 120.

Drives 117 can each be coupled to receive the fault-managed power from circuitry 116 and can further be coupled to provide power to downstream motors 120. More specifically, drive 117-1 can be coupled to motor 120-1, drive 117-2 can be coupled to motor 120-2, and drive 117-3 can be coupled to motor 120-3. Drives 117 and motors 120 may be coupled to each other via an interface. For example, drive 117-1 may be a DSD that couples to motor 120-1 via a cable. By way of another example, drive 117-2 may be a DSM that couples to motor 120-2 via an internal interface instead of external cabling. Any combination or variation may be used in operating environment 101.

Based on respective processes performed by motors 120, drives 117 may require different amounts of power. FMP receivers 115 may determine the amount of power required for each of drives 117. The total amount of power required by drives 117 may be referred to as the expected power consumption.

In operation, with respect to the fault-managed control power, FMP receivers 115 may determine the expected control power consumption of drives 117. FMP transmitter 110 provides, via the first continuous communication channel over SPE 108, the expected power consumption to bus power source 106. Bus power source 106 performs a comparison between the fault-managed control power and the expected control power consumption (by FMP transmitter 110 and/or FMP receivers 115) and determines whether there is a fault based on the comparison. More specifically, bus power source 106 can determine that there is a fault if the difference between the expected control power consumption and the fault-managed control power exceeds a threshold amount. In some cases, bus power source 106 may compare the expected control power consumption to the fault-managed control power less other power loss in circuitry 107 and circuitry 111, such as dissipation from electrical components. If bus power source 106 determines that there is a fault, bus power source 106 can immediately cease transmission of the fault-managed control power to FMP transmitter 110, which may prevent FMP transmitter 110 from providing the control power to FMP receivers 115. The fault may include one or more of a line-to-line fault, a line-to-ground fault, a malfunction in FMP transmitter 110 or FMP receivers 115, over-current, short-circuit, or any other issue that could cause shock or fire to people, structures, or components of operating environment 101, among other things.

In operation, with respect to the fault-managed power to drive drives 117, FMP receivers 115 may measure the power consumption of drives 117. FMP receivers 115 provide, via the second continuous communication channel over SPE 112, the power consumption to FMP transmitter 110. FMP transmitter 110 performs a comparison between the generated fault-managed power and the power consumption and determines whether there is a fault based on the comparison. More specifically, FMP transmitter 110 can determine that there is a fault if the difference between the measured power consumption and the generated fault-managed power exceeds a threshold amount. In some cases, FMP transmitter 110 may compare the measured power consumption to the generated fault-managed power less other power loss in circuitry 111, such as dissipation from electrical components, and in SPE 112. If FMP transmitter 110 determines that there is a fault, FMP transmitter 110 can immediately cease transmission of the fault-managed power to FMP receivers 115, and consequently, FMP receivers 115 can stop providing power to drives 117.

Referring next to FIG. 1B, operating environment 102 includes FMP transmitter 110 and FMP receivers 115 arranged in a star topology with respect to communications and power transmission. In this topology, each of FMP receivers 115 may be individually coupled to FMP transmitter 110 using SPE 112. FMP receiver 115-1 may be coupled to FMP transmitter 110 using SPE 112-1, FMP receiver 115-2 may be coupled to FMP transmitter 110 using SPE 112-2, and FMP receiver 115-3 may be coupled to FMP transmitter 110 using SPE 112-3. Power transmission and continuous communications may occur between FMP transmitter 110 and each of FMP receivers 115 individually. It follows that a fault occurring at one of FMP receivers 115 may cause FMP transmitter 110 to cease transmission of the fault-managed power to the faulted receiver but not the other receivers.

It may be appreciated that components of operating environment 102 may be capable of generating and transmitting both or either fault-managed control power, from bus power source 106 to FMP transmitter 110, and fault-managed power, from FMP transmitter 110 to FMP receivers 115 as in operating environment 101.

Referring next to FIG. 1C, operating environment 103 includes FMP transmitter 110 and FMP receivers 115 arranged in a multi-drop topology with respect to both DC power transmission and fault-managed power transmission. In this operating environment, FMP transmitter 110 may be coupled to FMP receiver 115-1 via SPE 112 and bus power line 113, FMP receiver 115-1 may be coupled to FMP receiver 115-2 via SPE 112 and bus power line 113, and FMP receiver 115-2 may be coupled to FMP receiver 115-3 via SPE 112 and bus power line 113. Bus power line 113 may be representative of power line cabling that can allow for transmission of class 1 or class 2 power from FMP transmitter 110 to FMP receivers 115. Accordingly, in this example, FMP transmitter 110 may not generate fault-managed power to drive loads, but rather, FMP transmitter 110 can provide a DC power from bus power source 106 to FMP receivers 115. Simultaneously, FMP transmitter 110 can provide communications and/or fault-managed control power to FMP receivers 115 via SPE 112. Thus, in such examples, only fault-managed control power may be used.

Referring next to FIG. 1D, operating environment 104 includes FMP transmitter 110 and FMP receivers 115 arranged in a ring topology with respect to fault-managed power and communications transmission. In this operating environment, FMP transmitter 110 may be coupled to FMP receiver 115-1 via SPE 112, FMP receiver 115-1 may be coupled to FMP receiver 115-2 via SPE 112, and FMP receiver 115-2 may be coupled to FMP receiver 115-3 via SPE 112. FMP receiver 115-3 may be coupled to FMP transmitter 110 via SPE 112.

In one example, FMP transmitter 110 may function as a “ring supervisor” whereby FMP transmitter 110 may transmit both fault-managed power and communications in one direction, such as to FMP transmitter 115-1, which would travel to FMP receiver 115-2 via FMP receiver 115-1 and to FMP receiver 115-3 via FMP receiver 115-2. If there are no faults within FMP transmitter or FMP receivers 115 and no cable breaks within SPE 112, the connection between FMP receiver 115-3 and FMP transmitter 110 may not be used outside of communications. More specifically, a switching device (not shown) may be included between FMP receiver 115-3 and FMP transmitter 110 and remain open such that no power travels between the two devices. If there is a fault or cable break, such as between FMP receiver 115-2 and FMP receiver 115-3, FMP transmitter 110 may close the switching device and send the fault-managed power and communications in both directions, such that FMP receiver 115-1 and FMP receiver 115-3 directly receive the fault-managed power and communications from FMP transmitter 110, which may create two independent linear topologies between FMP transmitter 110 and FMP receivers 115-1 and 115-3. In such an example, FMP transmitter 110 may employ a communications protocol, such as a Device Level Ring (DLR) protocol and/or a Media Redundancy Protocol (MRP), to detect physical breaks in SPE 112.

In another example, FMP transmitter 110 may transmit both fault-managed power and communications in both directions of the “ring” even under normal conditions where there is no fault. In this example, FMP transmitter 110 may employ a communication protocol to prevent duplications of communications, such as a High-Availability Seamless Redundancy (HSR) protocol.

In other embodiments, FMP transmitter 110 and FMP receivers 115 may be coupled using SPE 112 and/or bus power line 113 of FIG. 1C in other topologies. For example, FMP transmitter 110 and FMP receivers 115 may be arranged in the linear topology with respect to power transmission as well as communications transmission. In such an example, a fault detected in one of FMP receivers 115, such as FMP receivers 115-1, may not affect power or communications transmissions in other FMP receivers 115, or FMP receivers 115-2 and 115-3. It may be further appreciated that any number of FMP receivers 115 and respective circuitry 116 and drives 117 may be included in a system.

Regardless of which topology may be used, such use of fault-managed power transmitters and receivers may allow for a reduction in the amount of conductors and wires used in an environment, and thus, a reduction in cost. Further, such systems may safely provide fault-managed power, both for driving operations of devices and for initialization of components of devices and systems (i.e., control power), that can be monitored in accordance with safety protocols over SPE 112, terminated immediately upon detection of faults, and which may include increased power, voltage, and current relative to traditional power transmission methods, which provides flexibility in the operation of such connected loads (e.g., drives 117, motors 120, and components thereof), among other benefits.

In any one of the various topologies, when there are multiple loads on SPE 112, or multiple FMP receivers 115 with one or more of drives 117 and motors 120 as shown in FIGS. 1A, 1B, 1C, and 1D, FMP transmitter 110 and FMP receivers 115 can measure the power consumption in several ways. More specifically, in a first example, each FMP receiver may measure the power consumption of its own loads individually and provide the measured power consumption to FMP transmitter 110. FMP transmitter 110 may add up the measured power consumptions to determine a total measured power consumption and factor in dissipation and other losses within the system. In a second example, FMP transmitter 110 may instead measure power going out to FMP receivers 115 and measure power going into and out of each of FMP receivers 115. The FMP receivers 115 can provide measured power consumption from their loads, and FMP transmitter can subtract power generated by FMP transmitter 110 from losses in the system and power consumed in FMP receivers 115. In this example, FMP receivers 115 may provide measured power consumption at two different nodes within the FMP receiver, such as at an input node to the FMP receiver and at an output node of the FMP receiver that interfaces with another FMP receiver. FMP transmitter 110 may determine whether there is a fault at one or more of FMP receivers 115 based on a comparison of the input and output powers and terminate transmission of the fault-managed power to one or more of FMP receivers 115 (depending on the topology) in response to a detection of a fault. However, in some examples, a switch (e.g., an FET, switch, relay) may be included in each one of FMP receivers 115, which may be controllable by FMP transmitter 110 or by each individual FMP receiver. If FMP receivers 115 include such a switch controllable by FMP receivers 115, an FMP receiver may terminate further transmission of the fault-managed power to any FMP receivers coupled with a respective FMP receiver when the FMP receiver detects a fault within its own circuitry.

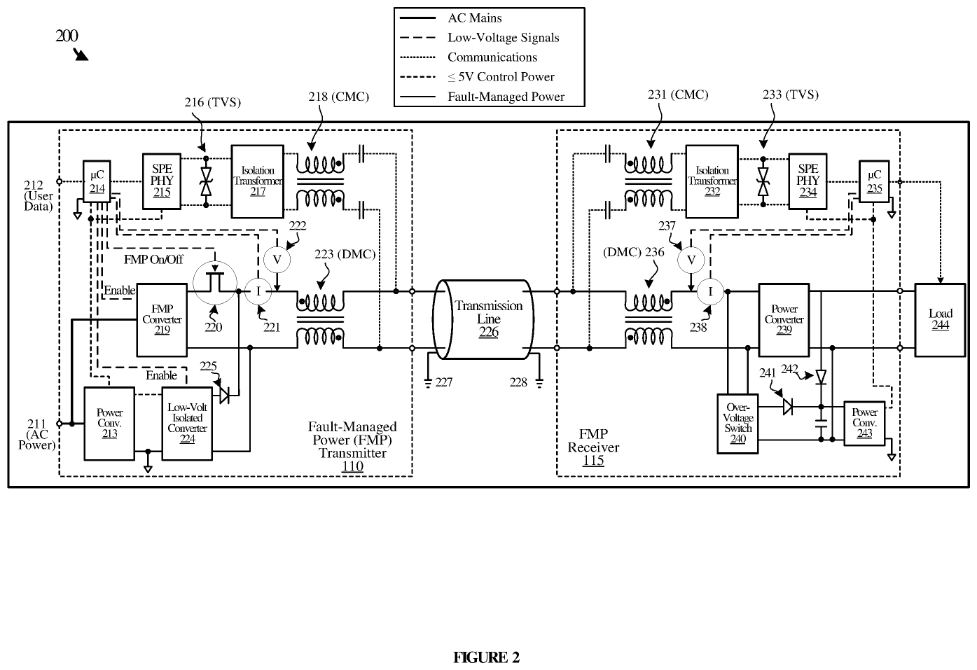

FIG. 2 illustrates an example block diagram of a fault-managed power system in accordance with some embodiments of the present technology. FIG. 2 includes system 200, which includes fault-managed power (FMP) transmitter 110, transmission line 226, FMP receiver 115, and load 244. FMP transmitter 110 includes various elements, such as power converter 213, microcontroller (denoted as μC in FIG. 2) 214, single-pair Ethernet physical layer (SPE PHY) 215, transient voltage suppression (TVS) 216, isolation transformer 217, common mode choke (CMC) 218, FMP converter 219, differential mode choke (DMC) 223, and low-voltage isolated converter 224, among other elements, which may be representative of circuitry 111. FMP receiver 115 includes various elements, such as DMC 236, CMC 231, isolation transformer 232, SPE PHY 234, microcontroller 235, power converter 239, over-voltage switch 240, and power converter 243, which may represent circuitry 116. In various examples, FMP transmitter 110 and FMP receiver 115 may exemplify fault-managed power components capable of performing fault-managed power processes, such as process 800 of FIG. 8.

System 200 is representative of a fault-managed power system capable of converting AC or DC power from a power source into fault-managed power to be transmitted over low-voltage cabling, as opposed to conventional electrical transmission cabling, for use downstream. More specifically, FMP transmitter 110 can obtain AC or DC power, convert the power to fault-managed power, and provide the fault-managed power to FMP receiver 115. FMP receiver 115 uses the fault-managed power to provide one or more loads (e.g., load 244) power to operate.

Fault-managed power (FMP) transmitter 110 is representative of a device, apparatus, or circuitry capable of receiving AC power 211 from a power source, converting the power into fault-managed power, and transmitting the fault-managed power to FMP receiver 115 over a transmission line 226. FMP transmitter 110 may further be capable of establishing a continuous communication channel with FMP receiver 115 via transmission line 226 for exchanging data signals between FMP transmitter 110 and FMP receiver 115. To perform power conversion and transmission, FMP transmitter 110 includes various circuits, devices, and other components. More particularly, FMP transmitter 110 may control the circuits, devices, and other components and operations of such elements using microcontroller 214. FMP transmitter 110 may initiate transmission of fault-managed power and communications following a start-up phase, which is described below with respect to FIG. 8.

Microcontroller 214 is representative of one or more processors or processing units capable of communicating with (i.e., via communications signals denoted by thin, dotted lines in FIG. 2) and controlling (i.e., via low-voltage signals denoted by thick, dashed lines in FIG. 2) components of FMP transmitter 110 and components of FMP receiver 115. For example, microcontroller 214 may be coupled with SPE PHY 215, FMP converter 219, power converter 213, and low-voltage isolated converter 224. Microcontroller 214 may perform one or more predetermined, or pre-programmed, operations to communicate with and control such components. Microcontroller 214 may also, or instead, receive user data 212 that may direct microcontroller 214 to perform such operations. In various examples, microcontroller 214 may also include Ethernet switching circuitry, such as a communications switch or bridge.

User data 212 may include user-defined signals that include parameters associated with other components of FMP transmitter 110, threshold values related to current and voltage of the fault-managed power, instructions for enabling or disabling transmission of the fault-managed power or components of FMP transmitter 110, and the like. User data 212 may also include data unrelated to the operations of FMP transmitter 110 and FMP receiver 115, such as data to and from load 244 (e.g., industrial devices 120) or to and from a programmable logic controller (PLC) (not shown) coupled to load 244. In an initial start-up phase of FMP transmitter 110 (e.g., operation 810 of process 800 of FIG. 8), microcontroller 214 may disable the generation of fault-managed power so that the fault-managed power cannot be transmitted to receiver 115 until other elements are initialized. For example, microcontroller 214 may first provide internal control power (denoted by the thin, dashed line in FIG. 2) to power converter 213 so that power converter 213 can receive AC power 211 and operate to convert AC power 211 to a value usable by FMP transmitter 110.

AC power 211 includes power from AC mains, such as a power grid, or any other source capable of producing AC power (e.g., main power source 105 of FIG. 1A). In some examples, AC power 211 may qualify as Class 1 or Class 2 power of the NEC. In other cases, however, AC power 211 may be a different class of power, or alternatively, transmitter 110 may receive DC power instead of AC power 211 (i.e., from a DC bus, such as bus power source 106 of FIG. 1A). FMP transmitter 110 receives AC power 211 at power converter 213 and at FMP converter 219 (denoted by the bolded solid line in FIG. 2).

Power converter 213 is representative of an AC-to-DC or DC-to-AC power converter capable of intaking AC power 211 and converting AC power 211 to a different AC value or to DC power. In some examples, power converter 213 may output an increased power, however, in other examples, power converter 213 may output a decreased power with respect to AC power 211. Power converter 213 may output a converted power to low-voltage isolated converter 224.

Low-voltage isolated converter 224 is representative of a power converter that may be capable of converting power output by power converter 213 to a low-voltage control power. In various examples, the low-voltage control power is DC power that may be provided over transmission line 226 to FMP receiver 115 to power-on components of FMP receiver 115 like power converter 243, microcontroller 235, and other components. The low-voltage control power may pass through diode 225 to further power-on current sensor 221 and voltage sensor 222.

After microcontroller 214 initializes components, such as power converter 213 and low-voltage isolated converter 224 of FMP transmitter 110, microcontroller 214 can check voltage and current values of signals on transmission line 226, via voltage sensor 222 and current sensor 221, to determine if power converter 213 and low-voltage isolated converter 224 are producing expected values.

Current sensor 221 and voltage sensor 222 are coupled between FMP converter 219 and DMC 223 to obtain current and voltage measurements at transmission line 226, respectively. It follows that current sensor 221 and voltage sensor 222 are sensors or devices capable of reading current values and voltage values, respectively. Microcontroller 214 can read the measurements as current passes through the sensors and can detect a fault in FMP transmitter 110 or FMP receiver 115 based on the measurements read by current sensor 221 and voltage sensor 222. In various examples, low-voltage isolated converter 224 may be designed to generate a 3.3 V output. Thus, microcontroller 214 may obtain measurements from voltage sensor 222 to determine whether the output meets or is approximately equal to the expected output of 3.3 V. Similarly, microcontroller 214 may determine an expected current by dividing the voltage from low-voltage isolated converter 224 by a resistance value associated with cables used in FMP transmitter 110. In some examples, the resistance values may be pre-programmed cable resistance determined at the time of design. In other examples, microcontroller 214 may use SPE PHY 215 to measure transmission line resistance.

SPE PHY 215 is representative of a physical layer that may provide an interface between FMP transmitter 110 and FMP receiver 115. More specifically, SPE PHY 215 may interface with SPE PHY 234 of FMP receiver 115 to establish a continuous communication channel. SPE PHY 234 is also representative of a physical layer for microcontroller 235. SPE PHYs 215 and 234 may perform negotiations and hand-shakes between each other to establish communication between microcontrollers 214 and 235. SPE PHYs 215 and 234 may also provide user data 212 between each other. SPE PHYs 215 and 234 communicate with each other via transmission line 226. Microcontroller 214, via SPE PHY 215 provides communications (denoted by the thin, dotted lines in FIG. 2) through TVS 216, isolation transformer 217, and CMC 218, which may provide filtering of data and communication signals when transmitting communications from microcontroller 214 to microcontroller 235. Similarly, microcontroller 235 receives and transmits communications, via SPE PHY 234, through TVS 233, isolation transformer 232, and CMC 231, which provide similar functionality.

In various examples, SPE PHYs 215 and 234 form a black channel over which a safety protocol, such as a black-channel safety protocol, a common industrial protocol (CIP), or another type of safety protocol, that meets packet transmission requirements and security requirements of a design may be used. If the measurements from current sensor 221 or voltage sensor 222 do not meet the expected values, microcontroller 214 can detect a fault and disable low-voltage isolated converter 224 and attempt to restart operations of power converter 213 and low-voltage isolated converter 224. If the measurements meet the expected values, SPE PHY 215 may initiate communications with FMP receiver 115 to ensure there are no faults at FMP receiver 115.

Transmission line 226 is representative of cabling used to physically couple FMP transmitter 110 and FMP receiver 115. In various examples, transmission line 226 is formed using single-pair Ethernet (SPE). SPE may include a pair of conductors (i.e., wires). Both conductors of the SPE may be used to transmit the fault-managed power from FMP transmitter 110 to FMP receiver 115 and to transmit data and communications simultaneously, such as user data 212, expected power consumption, and other information communicable via SPE PHYS 215 and 234. With SPE, full-duplex communications (i.e., communication in both directions) can occur as electrical signals transmitted over the conductors may be superimposed over power signals. In various examples, echo cancellation techniques may be used by FMP transmitter 110 and FMP receiver 115 so that signals leaving a respective SPE PHY do not return to the same SPE PHY's receiver circuitry. Transmission line 226 may also be coupled to ground nodes 227 and 228.

After low-voltage isolated converter 224 provides the low-voltage signal to FMP receiver 115, the low-voltage signal can pass through over-voltage switch 240, through diode 241, and to power converter 243. Over-voltage switch 240 is representative of a switch that allows or prevents current flow to power converter 243 based on the low-voltage signal provided by FMP transmitter 110. Similarly, over-voltage switch 240 and diode 241 may prevent current from flowing from power converter 243 to transmission line 226.

Power converter 243 is representative of a low-voltage power converter that performs DC-to-DC power conversion using the low-voltage power provided by FMP transmitter 110 and provides the converted DC power to power microcontroller 235 of FMP receiver 115, among other components of FMP receiver 115.

Microcontroller 235, like microcontroller 214 is representative of one or more processors or processing units capable of communicating with (i.e., via communications signals denoted by thin, dotted lines in FIG. 2) and controlling (i.e., via low-voltage signals denoted by thick, dashed lines in FIG. 2) components of FMP receiver 115, and further, communicating data and information to FMP transmitter 110. Microcontroller 235 may also include Ethernet switching circuitry, such as a communications switch or bridge, which may support the reception and distribution of communications between FMP receiver 115 and load 244. In an example, microcontroller 235 may be coupled with SPE PHY 234, power converter 239, and load 244. Via SPE PHYs 234 and 215, microcontroller 235 may be directed to measure line voltage and current on transmission line 226 using voltage sensor 237 and current sensor 238, representative of sensors capable of measuring values of voltage and current, respectively. Microcontroller 235 can provide such measurements to microcontroller 214 via SPE PHY 234.

Microcontroller 235 can check for several conditions with respect to the measured current and voltage at FMP receiver 115. For example, microcontroller 235 can determine whether the voltage at transmission line 226 in FMP receiver 115 meets or exceeds a threshold value (e.g., 3.3 V). Microcontroller 235 can also determine whether the current at transmission line 226 in FMP receiver 115 meets or exceeds a threshold value. Further, microcontroller 235 can compare the current measured at FMP receiver 115 via current sensor 238 and the current measured at FMP transmitter 110 via current sensor 221 to determine whether the current values are equal, or approximately equal, to each other within a threshold error value. Additionally, microcontroller 235 can compare the power transmitted from FMP transmitter 110 is equal, or approximately equal, to the power received at FMP receiver 115 within a threshold error value. If microcontroller 235 determines that all of the above conditions are met, microcontroller 235 can provide an indication of success to microcontroller 214 via SPE PHYs 215 and 234. If microcontroller 235 determines that one or more of the above conditions are not met, microcontroller 235 can provide an indication of a fault to FMP transmitter 110. Upon receiving the indication of the fault, FMP transmitter 110 can disable low-voltage isolated converter 224 and repeat initialization of components of FMP transmitter 110.

In various examples, microcontroller 235 may check for such conditions for a pre-determined amount of time or for a pre-determined number of times in accordance with a safety protocol. Similarly, microcontroller 214 may employ a watchdog timer to ensure that microcontroller 235 is providing indications of success or fault within a threshold time. If microcontroller 214 determines that microcontroller 235 has not provided an indication in accordance with the threshold time, microcontroller 214 can determine that a fault has occurred, and microcontroller 214 can disable low-voltage isolated converter 224. Additionally, if microcontroller 214 determines that data has been lost on transmission from microcontroller 235 to microcontroller 214 (e.g., two or more packets in a row), microcontroller 214 can determine that a fault has occurred.

If microcontroller 214 does not detect any faults following initialization of the low-voltage signals and communication between microcontrollers 214 and 235, microcontroller 214 can direct FMP converter 219 to turn on to begin generating fault-managed power. FMP converter 219 is representative of an AC-to-DC power converter that can convert AC power 211 from the power source (denoted by the bolded, solid line in FIG. 2) to DC power of approximately 400 VDC. FMP converter 219 outputs the fault-managed power to FMP receiver 115 via transmission line 226.

Transistor 220 is coupled between FMP converter 219 and transmission line 226 and may prevent the fault-managed power from flowing to FMP receiver 115 if disabled. Microcontroller 214 is coupled to a gate of transistor 220 and can control whether the fault-managed power can flow through transistor 220 to FMP receiver 115 or not. For example, microcontroller 214 may cause transistor 220 to prevent the fault-managed power from passing through transistor 220 if microcontroller 214 detects a fault or determines that FMP receiver 115 is not yet powered-on, load 244 is not connected, or for some other reason. While transistor 220 is depicted as a single transistor, multiple transistors, or any other type of switching or gating device, may be used.

DMC 223 is also included on transmission line 226 within FMP transmitter 110. DMC 223 may be included to filter noise from the fault-managed power generated by FMP converter 219 before the fault-managed power is provided to FMP receiver 115 via transmission line 226. Similarly, DMC 236 is included on transmission line 226 within FMP receiver 115 and may filter noise from the fault-managed power before reaching power converter 239 and load 244.

In various examples, the fault-managed power generated by FMP converter 219 is provided to FMP receiver 115 as an unpulsed signal (i.e., 100% duty cycle) (denoted by the thin, solid line in FIG. 2) via transmission line 226. While the fault-managed power is being transmitted to FMP receiver 115, microcontroller 235 can identify current and voltage measurements of the fault-managed power received at FMP receiver 115 via current sensor 238 and voltage sensor 237, respectively. Additionally, microcontroller 235 can identify an expected power consumption of the fault-managed power by load 244. Microcontroller 235 can provide the measurements and the expected power consumption to microcontroller 214 via SPE PHY 234 and in accordance with a safety protocol (i.e., within a pre-determined amount of time). Microcontroller 214 can check for several conditions with respect to the measured current and voltage of the fault-managed power at FMP receiver 115. For example, microcontroller 214 can determine whether the voltage at transmission line 226 in FMP receiver 115 is below a threshold value (e.g., 450 V). Microcontroller 214 can also determine whether the current at transmission line 226 in FMP receiver 115 is within a threshold range expected from FMP converter 219 based on the measurements provided to microcontroller 214. Further, microcontroller 214 can compare the current measured at FMP receiver 115 via current sensor 238 and the current measured at FMP transmitter 110 via current sensor 221 to determine whether the current values of the fault-managed power, before and after transmission, are equal, or approximately equal, to each other within a threshold error value. Microcontroller 214 may also compare the power transmitted from FMP transmitter 110 is equal, or approximately equal, to the power received at FMP receiver 115 within a threshold error value. Additionally, microcontroller 214 can compare the expected power consumption with the amount of fault-managed power transmitted by FMP transmitter 110.

If microcontroller 214 determines that all of the above conditions are met, microcontroller 214 can provide an indication of success to microcontroller 235 via SPE PHYS 215 and 234. In various examples, microcontroller 214 provides the indication according to a safety protocol, or in other words, with a packet interval meeting or exceeding a threshold packet interval (e.g., 0.5 millisecond packet interval). Power converter 239 can receive the fault-managed power and convert the fault-managed power to a different DC power or to AC power for consumption by load 244. Power converter 239 is coupled to provide the converted fault-managed power to load 244.

Load 244 is representative of one or more distributed drives operating in an industrial automation environment, commercial environment, or industrial environment. For example, load 244 may be representative of one of drives 117 of FIG. 1A. While load 244 is shown as a single box in FIG. 2, load 244 may include several loads, each coupled to FMP receiver 115 to receive fault-managed power.

While FMP converter 219 is enabled and transmitting the fault-managed power to FMP receiver 115, low-voltage isolated converter 224 may stay enabled, however, the low-voltage power may not transmit via transmission link 226 as diode 225, coupled between low-voltage isolated converted 224 and transmission link 226 may be reverse-biased and prevent the low-voltage power from flowing through diode 225 to transmission link 226.

If microcontroller 235 determines that one or more of the above conditions are not met, microcontroller 235 can provide an indication of a fault to FMP transmitter 110. Upon receiving the indication of the fault, FMP transmitter 110 can disable transistor 220 and/or FMP converter 219 to prevent transmission of the fault-managed power to FMP receiver 115. In FMP receiver 115, over-voltage switch 240 can prevent the fault-managed power from flowing to power converter 243 to prevent damage of power converter 243. Microcontroller 214 can wait a pre-determined amount of time or for user data 212 before beginning transmission of the fault-managed power again.

In various other examples, additional, fewer, or different components may be included in or coupled to FMP transmitter 110 and FMP receiver 115. Additionally, components thereof may be coupled or wired to each other in different manners, which may create different topologies or architectures. In other words, any combination or variation of circuitry in FMP transmitter 110 and FMP receivers 115 may be utilized to drive DC motors (e.g., motors 117) using pulsed signals over SPE.

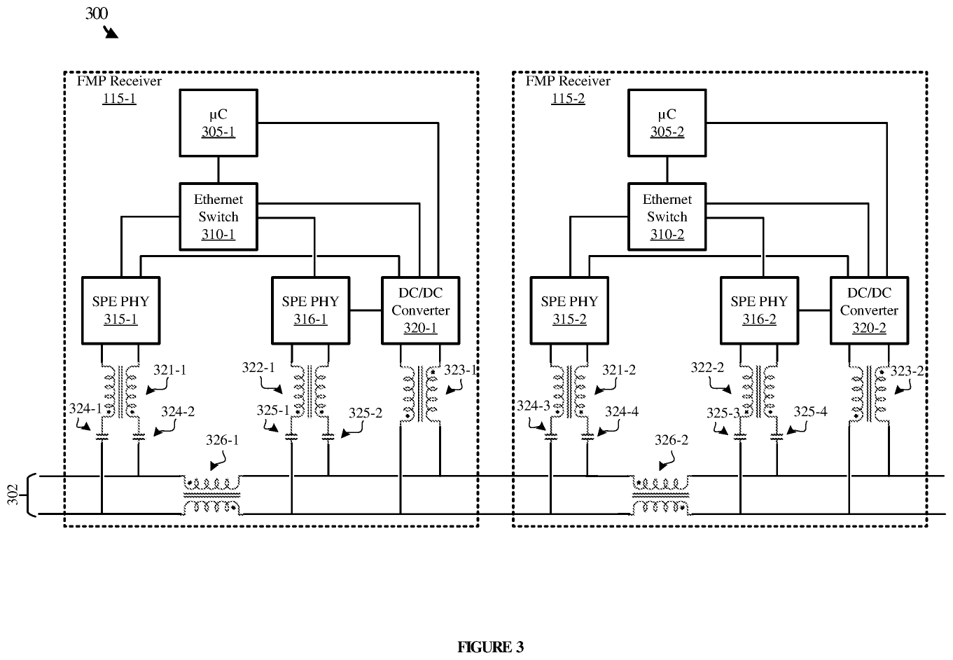

FIG. 3 illustrates an example block diagram of components of a fault-managed power system in accordance with some embodiments of the present technology. FIG. 3 includes operating environment 300, which includes fault-managed power (FMP) receivers 115-1 and 115-2 coupled together via single-pair Ethernet (SPE) 302. FMP receiver 115-1 includes microcontroller (denoted by μC in FIG. 3) 305-1, Ethernet switch 310-1, SPE physical layer (PHY) 315-1, SPE PHY 316-1, DC/DC converter 320-1, common-mode choke (CMC) 321-1, CMC 322-1, differential-mode choke (DMC) 323-1, capacitors 324-1, 324-2, 325-1, and 325-2, and DMC 326-1. Similarly, FMP receiver 115-2 includes microcontroller 305-2, Ethernet switch 310-2, SPE PHY 315-2, SPE PHY 316-2, DC/DC converter 320-2, CMC 321-2, CMC 322-2, DMC 323-2, capacitors 324-3, 324-4, 325-3, and 325-4, and DMC 326-2.

FMP receivers 115-1 and 115-2 (collectively FMP receivers 115) may be representative of fault-managed receivers used in a fault-managed power system, such as two of FMP receivers 115 of FIG. 1A. In operating environment 300, FMP receivers 115-1 and 115-2 may be coupled in a multi-drop topology where FMP receiver 115-1 is coupled to a transmitter (e.g., FMP transmitter 110 of FIG. 1A) via a transmission line formed using SPE 302, and FMP receiver 115-2 is coupled to FMP receiver 115-1 along SPE 302. While only two receivers are shown, additional receivers may also be included and coupled along SPE 302. The transmitter may provide both fault-managed power and data signals to FMP receivers 115 using SPE 302.

SPE 302 can be formed using low-voltage wires including a pair of conductors that may be used to transmit and receive both power and data over the same pair of conductors. Accordingly, the pair of conductors may be used to transmit the fault-managed power from the transmitter to FMP receivers 115 and communications between the transmitter and FMP receivers 115. FMP receivers 115-1 and 115-2 include various components for receiving the fault-managed power and data and communications from the transmitter via SPE 302, such as SPE PHYs 315 and 316, DC/DC converters 320. Each conductor of SPE 302 may be coupled to different components of FMP receivers 115. Specifically, a first conductor of SPE 302 may be coupled to capacitor 324-1, capacitor 325-1, and first terminals of DMCs 323-1 and 326-1 of FMP receiver 115-1 and capacitor 324-3, capacitor 325-3, and first terminals of DMCs 323-2 and 326-2 of FMP receiver 115-2. A second conductor of SPE 302 may be coupled to capacitor 324-2, capacitor 325-2, and second terminals of DMCs 323-1 and 326-1 of FMP receiver 115-1 and capacitor 324-4, capacitor 325-4, and second terminals of DMCs 323-2 and 326-2 of FMP receiver 115-2.

Each of the capacitors and CMCs of receivers 115-1 and 115-2 may be included to prevent DC fault-managed power flowing through SPE 302 from reaching the SPE PHYs, as the fault-managed power may cause damage to the SPE PHYs, while also allowing communications flowing through SPE 302 to be received by and transmitted from the SPE PHYs. For example, capacitors 324-1 and 324-2 may be coupled to CMC 321-1, which is further coupled to SPE PHY 315-1. Capacitors 325-1 and 325-2 may be coupled to CMC 322-1, which is further coupled to SPE PHY 316-1. Capacitors 324-3 and 324-4 may be coupled to CMC 321-2, which is further coupled to SPE PHY 315-2. Capacitors 325-3 and 325-4 may be coupled to CMC 322-2, which is further coupled to SPE PHY 316-2.

Each of the DMCs of receivers 115-1 and 115-2 may be included to filter noise in the electrical current flowing through SPE 302. For example, in FMP receiver 115-1, DMC 326-1 may be coupled along SPE 302 between various components of FMP receiver 115-1, and DMC 323-1 may be further coupled between SPE 302 and DC/DC converter 320-1. Likewise, in FMP receiver 115-2, DMC 326-2 may be coupled along SPE 302 between various components of FMP receiver 115-2, and DMC 323-2 may be further coupled between SPE 302 and DC/DC converter 320-2.

The SPE PHYs and DC/DC converters of FMP receivers 115-1 and 115-2 may each be coupled with Ethernet switches 310-1 and 310-2, respectively. Ethernet switches 310-1 and 310-2 may be included to establish a communication network and connect components of FMP receivers 115 to the communication network. Ethernet switches 310-1 and 310-2 may include a network switch and other network hardware and may be coupled with each of the SPE PHYs and DC/DC converters via low-voltage, Ethernet cables. Ethernet switches 310-1 and 310-2 may be controlled by microcontrollers 305-1 and 305-2, respectively.

The SPE PHYs may also be coupled with the DC/DC converters of FMP receivers 115-1 and 115-2. Specifically, SPE PHYs 315-1 and 316-1 may be coupled with DC/DC converter 320-1, and SPE PHYs 315-2 and 316-2 may be coupled with DC/DC converter 320-2. DC/DC converters 320-1 and 320-2 may be representative of power converters (e.g., buck converters, boost converters, buck-boost converters) that can receive the fault-managed power from SPE 302 via DMCs 323-1 and 323-2, respectively, and convert the fault-managed power to a DC power. In an example, while not shown in operating environment 300, each of DC/DC converters 320-1 and 320-2 may be further coupled with a distributed drive (e.g., one of drives 117) or a different load. The conversion of the fault-managed power for driving the drives may depend on the type of drive, the operation mode of the drive, the load (e.g., motor) coupled with the drive, and the like. Microcontrollers 305-1 and 305-2 may be coupled with DC/DC converters 320-1 and 320-2, respectively, to control functionality of DC/DC converters 320-1 and 320-2. In such an example, additional DC-to-DC converters may be included and coupled between DC/DC converters 320 and the loads or other components based on voltage needs of the coupled devices. In another example, the distributed drives or other loads may be coupled to DMC 326-1 and DMC 326-2 of FMP receivers 115-1 and 115-2, respectively.

Microcontrollers 305-1 and 305-2 are representative of one or more processors or processing units (e.g., microcontroller 214 of FIG. 2) capable of communicating with and controlling components of receivers 115-1 and 115-2, respectively. For example, microcontroller 305-1 may be coupled with Ethernet switch 310-1 and DC/DC converter 320-1. Microcontroller 305-2 may be coupled with Ethernet switch 310-2 and DC/DC converter 320-2. Microcontrollers 305-1 and 305-2 may perform one or more predetermined, or pre-programmed, operations to communicate with and control such components. Microcontrollers 305-1 and 305-2 may also, or instead, receive user data that may direct microcontrollers 305-1 and 305-2 to perform such operations.

In operation, microcontroller 305-1 may direct SPE PHYs 315-1 and 316-1 to establish a continuous communication channel with SPE PHYs of the transmitter in response to a request to establish the continuous communication channel from the transmitter. Similarly, microcontroller 305-2 may direct SPE PHYs 315-2 and 316-2 to establish a continuous communication channel with the SPE PHYs of the transmitter. In some embodiments, microcontrollers 305-1 and 305-2 may also establish a continuous communication network with each other. The SPE PHYs of FMP receivers 115-1 and 115-2 may transmit communications through SPE 302 to the transmitter using low-voltage signals. Capacitors of FMP receivers 115-1 and 115-2 may allow communications to flow through respective CMCs and to SPE PHYs as the voltage of the communication signals may not surpass a threshold voltage.

Simultaneously, a transmitter may provide fault-managed power to FMP receivers 115-1 and 115-2 via SPE 302. In various examples, the transmitter provides the fault-managed power to FMP receivers 115-1 and 115-2 over SPE 302 as an unpulsed signal. In other words, the transmitter generates a signal having a duty cycle of 100%. In other examples, the signal may have a duty cycle of less than 100%. When using a pulsed signal, the transmitter may provide the fault-managed power in a way that mimics a pulse-width modulated signal. The communications between the transmitter and FMP receivers 115-1 and 115-2 may ride over the fault-managed power, but the communications may also persist despite breaks in the power transmission, such as when the pulsed signal is low (i.e., off).

Unlike the low-voltage signals, the fault-managed power may include a high-voltage signal. Thus, the capacitors of FMP receivers 115-1 and 115-2 may prevent the fault-managed power from traveling to SPE PHYs 315-1, 316-1, 315-2, and 316-2. DC/DC converters 320-1 and 320-2 may each receive the fault-managed power and convert the fault-managed power based on respective motors. Microcontrollers 305-1 and 305-2 may identify the amount of fault-managed power received by DC/DC converters 320-1 and 320-2, respectively, and the amount of expected power consumption by each motor coupled with DC/DC converters 320-1 and 320-2, respectively. The expected power consumption may refer to the amount of power to be used during operation of the motor. The expected power consumption of a motor coupled with DC/DC converter 320-1 may differ from the expected power consumption of a motor coupled with DC/DC converter 320-2. Microcontrollers 305-1 and 305-2 may communicate the expected power consumptions to the transmitter via SPE PHYs 315-1 and 316-1 and SPE PHYs 315-2 and 316-2, respectively.

The transmitter may perform a comparison between the total expected power consumption, the fault-managed power, and other expected losses throughout the system based on SPE 302, electrical components of the transmitter and FMP receivers 115-1 and 115-2, and the like. Based on the comparison, the transmitter may detect a fault in the transmitter, SPE 302, FMP receiver 115-1, or FMP receiver 115-2. If the transmitter detects a fault in any one of receivers 115-1 or 115-2 or in a component of the transmitter, the transmitter may terminate transmission of the fault-managed power to FMP receivers 115-1 and 115-2. Accordingly, in this multi-drop topology, termination of the fault-managed power terminates power to both FMP receivers 115-1 and 115-2.

In other embodiments, a different number of receivers, a different number or type of components of FMP receivers 115-1 and 115-2, or a different topology may be employed. For example, FMP receivers 115-1 and 115-2 may include various components of FMP receiver 115 of FIG. 2. In a different topology, the transmitter may be individually coupled to each of FMP receivers 115-1 and 115-2, such that if the transmitter detects a fault in FMP receiver 115-1 but not in FMP receiver 115-2, the transmitter may terminate transmission of the fault-managed power to only FMP receiver 115-1.

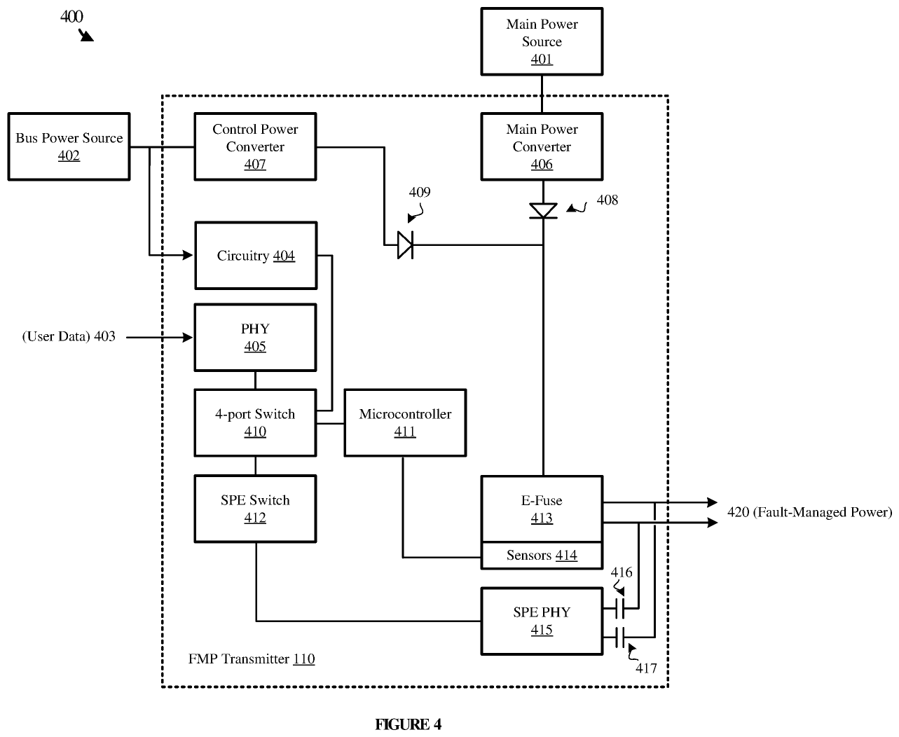

FIG. 4 illustrates an example block diagram of components of a fault-managed power system in accordance with some embodiments of the present technology. FIG. 4 includes block diagram 400, which includes FMP transmitter 110, and components thereof, and main power source 401 and bus power source 402. FMP transmitter 110 further includes circuitry 404, physical layer (PHY) 405, main power converter 406, control power converter 407, diodes 408 and 409, 4-port switch 410, microcontroller 411, single-pair Ethernet (SPE) switch 412, E-fuse 413, sensors 414, SPE physical layer (PHY) 415, and capacitors 416 and 417, which may be representative of circuitry 111. FMP transmitter 110 may be configured to generate fault-managed power 420 based on power from main power source 401 and bus power source 402.

Main power source 401 is representative of any alternating current (AC) or direct current (DC) power source. For example, main power source 401 may be AC mains electricity or a DC source, such as a rectifier or fuel cell. In some examples, main power source 401 may produce power categorized under Class 1 or Class 2 power of the NEC. Main power source 405 may be coupled to FMP transmitter 110, or main power converter 406 of FMP transmitter 110, to provide power to FMP transmitter 110.

Bus power source 402 is representative of a DC power source, such as a DC bus, that can provide a control power to FMP transmitter 110, among other components of a system. In various examples, bus power source 402 may receive power, such as from main power source 401, and generate a DC power that may have a smaller value than the main power provided to bus power source 402. Bus power source 402 may be coupled with circuitry 404 and control power converter 407 of FMP transmitter 110 and provide the DC control power to both circuitry 404 and control power converter 407.

FMP transmitter 110 is representative of a transmitter device, apparatus, or circuitry capable of receiving the control power from bus power source 402 via a first connection, receiving the main power from main power source 401, generating fault-managed power 420 based on the power from main power source 401, and providing both the fault-managed power 420 downstream to one or more receivers (e.g., FMP receivers 115 of FIG. 1A, FMP receiver 115 of FIG. 2, FMP receivers 115 of FIG. 3) over a transmission line or link formed using single-pair Ethernet (SPE) cabling (e.g., SPE 112 of FIG. 1A). FMP transmitter 110 may further be capable of establishing a continuous communication channel with downstream receivers via the transmission line for exchanging data signals between FMP transmitter 110 and the receivers.

FMP transmitter 110 includes main power converter 406 and control power converter 407 configured to convert respective powers to different powers and provide power to E-fuse 413. Control power converter 407 may be a DC/DC power converter configured to step up or down the DC power provided by bus power source 402 to another DC control power. Main power converter 406 may be an AC/DC power converter, a DC/DC power converter, or another type of power converter, configured to convert the AC main power to a different power usable by E-fuse 413.

Diodes 408 and 409 may be representative of circuitry capable of providing a diode-like function, such as an active ideal diode or a MOSFET. Diodes 408 and 409 are included between main power converter 406 and E-fuse 413 and control power converter 407 and E-fuse 413, respectively, to prevent power generated by E-fuse 413 from flowing from E-fuse 413 back to main power converter 406 or control power converter 407.

E-fuse 413 is representative of circuitry capable of generating fault-managed power 420 based on power from main power converter 406. E-fuse 413 may include one or more power converters, transformers, or other power-related devices for generating the fault-managed power. In various examples, E-fuse 413 may be referred to as a power interface module that can interface with several receivers via SPE. E-fuse 413 includes sensors 414, such as voltage sensors, current sensors, temperature sensors, and the like, configured to measure values of fault-managed power 420 and the power provided by main power converter 406 and control power converter 407.

FMP transmitter 110 also includes circuitry 404, PHY 405, 4-port switch 410, microcontroller 411, SPE switch 412, and SPE PHY 415 to transmit communications and data to the downstream receivers. Circuitry 404 is representative of one or more circuits, hardware components, or other devices capable of providing a data path between bus power source 402 and 4-port switch 410. For example, circuitry 404 may include one or more components illustrated in FIGS. 2 and 3, such as capacitors 324, CMCs 321, and SPE PHYs 315. PHY 405 is representative of a physical layer component that can provide an external port connection between some infrastructure external to FMP transmitter 110 to 4-port switch 410. PHY 405 can allow user data 403, such as various communications or other system data, to be provided to FMP transmitter 110. 4-port switch 410 is representative of a network switch or device having multiple ports used for communicating with other elements of a system via a communication network. Similarly, SPE switch 412 is also representative of a network switch or device coupled to 4-port switch 410 and SPE PHY 415.

Microcontroller 411 may be coupled with 4-port switch 410, and more specifically, may direct 4-port switch 410 in the selection of downstream receivers to which to communicate with. Microcontroller 411 is representative of one or more processors or processing units capable of controlling operations of FMP transmitter 110 and communicating with and controlling components of the downstream receivers via SPE switch 412 and SPE PHY 415. In various examples, as E-fuse 413 generates fault-managed power 420, microcontroller 411 receives measurements from sensors 414 and determines whether there are any faults (i.e., changes in current or voltage values that exceed pre-determined threshold values) in main power converter 406, control power converter 407, E-fuse 413, or elsewhere in FMP transmitter 110. If microcontroller 411 detects a fault, microcontroller 411 may direct E-fuse 413 to terminate transmission of fault-managed power 420.

SPE PHY 415 is representative of a physical layer that may provide an interface between FMP transmitter 110 and the downstream receivers. More specifically, SPE PHY 415 may interface with SPE PHYs of the receivers to establish a continuous communication channel. SPE PHY 415 may perform negotiations and hand-shakes between each other SPE PHY to establish communication between microcontrollers 411 and other microcontrollers within respective receivers. Microcontroller 411 may control which SPE PHY and receiver that SPE PHY 415 communicates with at a given time by using SPE switch 412.

Capacitors 416 and 417 are coupled between SPE PHY 415 and the transmission line from E-fuse 413 to the downstream receivers. Capacitors 416 and 417 function to prevent current from flowing from E-fuse (i.e., fault-managed power 420) to SPE PHY 415 to prevent damage to SPE PHY 415. However, capacitors 416 and 417 may not prevent bi-directional communications from SPE PHY 415 to the downstream receivers and from the downstream receivers to SPE PHY 415 via the continuous communication channel established using the transmission link.

The transmission link FMP transmitter 110 to the downstream receivers may be formed using SPE cabling. The SPE may include a pair of conductors that may be used to transmit fault-managed power 420 from FMP transmitter 110 to the receivers and to exchange communications, that may ride on top of fault-managed power 420, between FMP transmitter 110 and the receivers.

During transmission of fault-managed power 420, sensors 414 may sense measurements of voltage and current of fault-managed power 420 to detect faults. Additionally, each of the receivers operating using fault-managed power 420 may include sensors that measure fault-managed power 420 received at the receiver. All voltage and current measurements captured by sensors 414 and other sensors may be communicated via the SPE to microcontroller 411 via SPE PHY 415, among other SPE PHYs. Microcontroller 411 can compare the measured voltages and currents to threshold values. If microcontroller 411 detects a fault, microcontroller 411 can direct E-fuse 413 to cease transmission of fault-managed power 420.

While only one E-fuse 413 is shown in block diagram 400, several E-fuses may be included, and each E-fuse may couple to individual receivers. Advantageously, such coupling between individual receivers and E-fuses may allow FMP transmitter 110 to cease transmission of fault-managed power 420 to only faulty receivers, such as in a star topology. Further, E-fuse 413, among other E-fuses, may also generate fault-managed control power based on the DC control power provided by control power converter 407. E-fuse 413 may similarly transmit such fault-managed control power over the same or a different SPE.

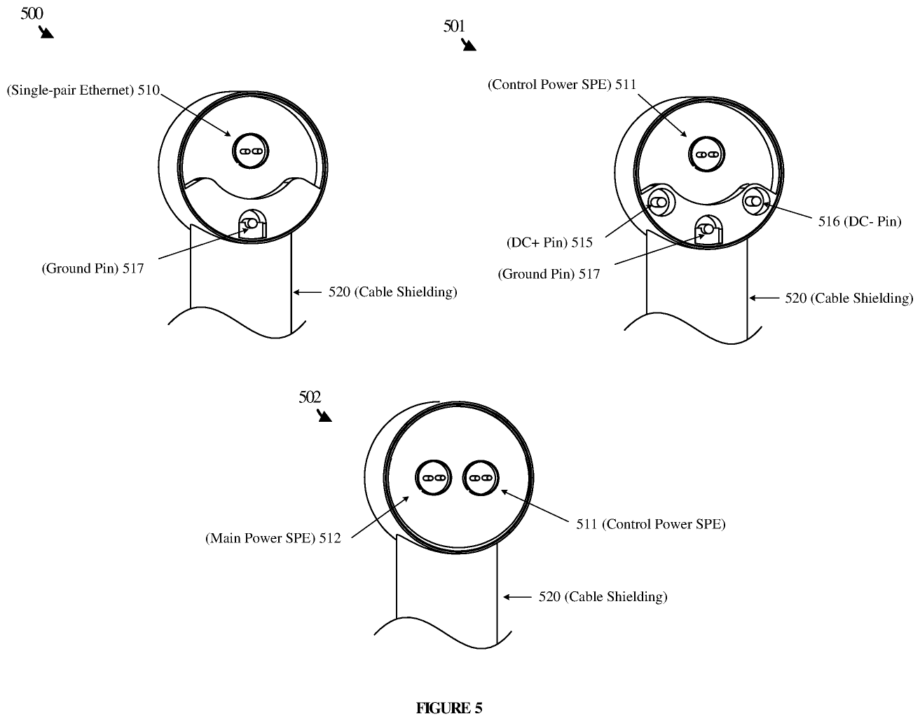

FIG. 5 illustrates example devices that may be used to connect components of a fault-managed power system in accordance with some embodiments of the present technology. FIG. 5 includes connectors 500, 501, and 502, which each include various pins, plugs, and associated conductors for coupling a fault-managed power transmitter, such as FMP transmitter 110 of FIG. 1A, to a fault-managed power receiver, such as FMP receiver 115-1 of FIG. 1A. More specifically, connector 500 includes single-pair Ethernet (SPE) 510 and ground pin 517. Connector 501 includes control power SPE 511, DC+ pin 515, DC− pin 516, and ground pin 517. Connector 502 includes control power SPE 511 and main power SPE 512. Each pin may couple to a conductive cable that may be enclosed within and protected by cable shielding 520.

In various examples, one of connectors 500, 501, and 502 may be used at both a transmitter and at a receiver of a fault-managed power system. The wires within cable shielding 520 may be used as a transmission line (e.g., SPE 112, transmission line 226) capable of transferring fault-managed power and communications between the transmitter and receiver.

More specifically, connector 500 may be used in a fault-managed power system that can generate and transmit a fault-managed power and communications over SPE 510, such as in a system including FMP transmitter 510 and one or more of FMP receivers 515 as in one of FIG. 1A or 1B. SPE 510 includes a pair of conductors by which both power and communications can travel. The fault-managed power transmittable over SPE 510 may be a fault-managed main power usable to drive loads (e.g., drives 117, motors 120) or a fault-managed control power or both. Ground pin 517 may also be included to provide a connection to protective Earth.

Connector 501 may be used in a fault-managed power system that can generate and transmit a fault-managed control power and communications over control power SPE 511 and a main DC power over DC+ pin 515, DC− pin 516, and ground pin 517, such as in a system including FMP transmitter 510 and one or more of FMP receivers 515 as in FIG. 1C. Control power SPE 511 may include a pair of conductors by which both power and communications can travel. The fault-managed control power may be a DC control power generated by either a DC bus power source (e.g., bus power source 106) or a FMP transmitter (e.g., FMP transmitter 510) for start-up and control operations of loads (e.g., drives 117, motors 120). DC+ pin 515 may provide a connection pin that can be used to transfer a positive DC voltage between a transmitter and receiver. On the other hand, DC− pin 516 may be used to transfer a negative or zero voltage signal between a transmitter and receiver. In other words, DC− pin 511 may be a return voltage pin. Ground pin 517 may be used to ground the voltage signal at a protective Earth node. DC+ pin 515, DC− pin 516, and ground pin 517 may be coupled to a transmitter and receiver in a bus power line, such as bus power line 113 of FIG. 1C.

Connector 502 may be used in a fault-managed power system that can generate and transmit a fault-managed main power, a fault-managed control power, and communications over main power SPE 512 and control power SPE 511, respectively, such as in a system including FMP transmitter 510 and one or more of FMP receivers 515 as in FIG. 1A or 1B. Main power SPE 515 includes a pair of Ethernet conductors that may be used to transmit the fault-managed main power and communications between the transmitter and receiver. In particular, the fault-managed main power transmitted through main power SPE 512 may be used to drive one or more distributed drives or large servo motors (e.g., drives 117). Communications may also transmit over main power SPE 512 as superimposed signals riding over the fault-managed power. Similarly, control power SPE 511 includes a pair of Ethernet conductors that may be used to transmit fault-managed control power and communications between the transmitter and receiver. Unlike main power SPE 515, the power transmitted through control power SPE 516 may be a DC control power used for components of a distributed drive, large servo, or for initialization processes (i.e., not typically for primary functionality of the receiving component).

While connectors 500, 501, and 502 each include multiple conductors shown bundled together via cable shielding 520, the pairs of conductors (e.g., SPE 510, control power SPE 511, main power SPE 512) may be bundled separately from each other and from DC or ground pins in some embodiments. For example, in an embodiment such as one illustrated by FIG. 1C, fault-managed power and DC power may be wired separately relative to one another.

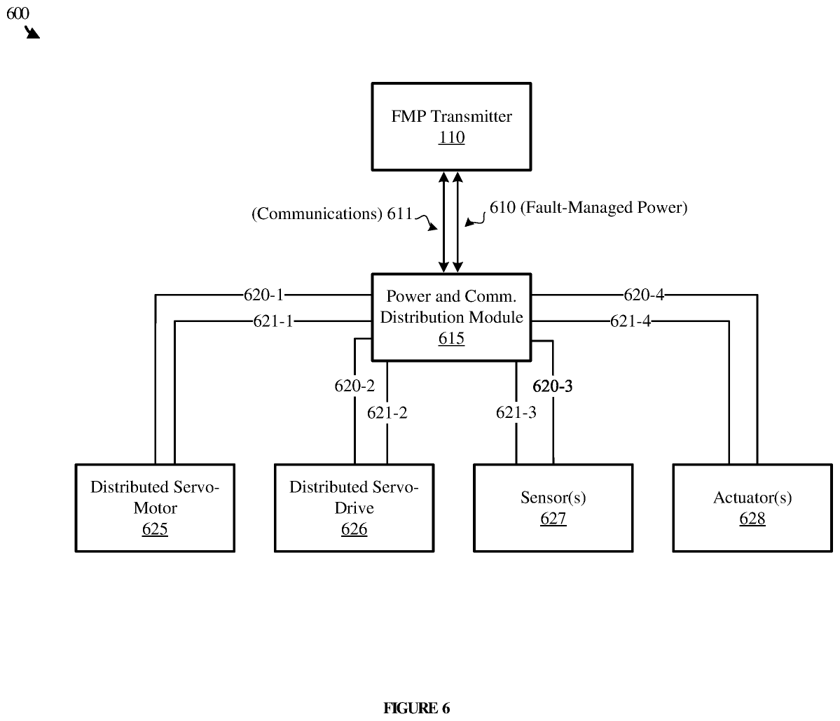

FIG. 6 illustrates an example block diagram of components of a fault-managed power system in accordance with some embodiments of the present technology. FIG. 6 includes block diagram 600, which includes FMP transmitter 110, power and communications distribution module 615, distributed servo-motor (DSM) 625, distributed servo-drive (DSD) 626, sensor(s) 627, and actuator(s) 628. In various examples, FMP transmitter 110 may be configured to generate and provide fault-managed power 610 and communication 611, and power and communications distribution module 615 may be configured to use fault-managed power 610 to generate class ½ power 620 and provide class ½ power 620 to one or more of DSM 625, DSD 626, sensor(s) 627, and actuator(s) 628.

FMP transmitter 110 is representative of a transmitter device, apparatus, or circuitry capable of generating and transmitting fault-managed power 610, communications 611, and other data to power and communications distribution module 615 via a transmission line for power and communications distribution module 615 to power various downstream components of an industrial, commercial, or industrial automation environment. FMP transmitter 110 may provide fault-managed power 610 and communications 611 over single-pair Ethernet (SPE) (e.g., SPE 112), however, in some examples, FMP transmitter 110 may provide fault-managed power 610 over a bus line (e.g., bus power line 113) and communications 611 over SPE. In various examples, FMP transmitter 110 includes circuitry (e.g., circuitry 111 of FIG. 1A, components of FMP transmitter 110 of FIG. 2) capable of generating fault-managed power 610 based on a power received by a power source (e.g., main power source 105 of FIG. 1A).

Fault-managed power 610 may be a Class 4 power that can be provided over low-voltage cabling, such as single-pair Ethernet (SPE), unlike Class 1 or Class 2 power under the NEC. SPE may include a pair of conductors that can transfer both power and communications/data over the same lines.

FMP transmitter 110 can produce fault-managed power 610 and provide fault-managed power 610 to power and communications distribution module 615 over the SPE. FMP transmitter 110 can also establish a continuous communication network with power and communications distribution module 615 over the SPE. To do so, FMP transmitter 110 may employ a SPE physical layer to interface with power and communications distribution module 615. Once established, FMP transmitter 110 and power and communications distribution module 615 may send data packets to each other that ride over fault-managed power 610.

Power and communications distribution module 615 is representative of a receiver device, apparatus, or circuitry capable of receiving fault-managed power 610 and communications and data, determining an expected power consumption of each coupled device (e.g., DSM 625), providing an indication of total expected power consumption by each device coupled with power and communications distribution module 615 to FMP transmitter 110, and driving the coupled devices using power based on fault-managed power 610. For example, power and communications distribution module 615 may include circuitry (e.g., circuitry 116 of FIG. 1A, components of FMP receiver 115 of FIG. 2, components of FMP receivers 115 of FIG. 3) to perform such functionality. Power and communications distribution module 615 may further include a network switch and other network communications devices, such as a router, gateway, or other communications protocol translators to communicate with DSM 625, DSD 626, sensors 627, and actuators 628 via the SPE, standard Ethernet, or some other communications protocol.

In various examples, each coupled device may use a different type or amount of power. Power and communications distribution module 615 can determine the total amount of power required to drive the coupled devices and provide an indication of total expected power consumption to FMP transmitter 110 via the continuous communication channel established using the SPE. FMP transmitter 110 can identify whether there is a fault in FMP transmitter 110, power and communications distribution module 615, or between the two based on a comparison between total expected power consumption and fault-managed power 610. If FMP transmitter 110 detects a fault, FMP transmitter 110 can terminate transmission of fault-managed power 610 to power and communications distribution module 615 until the fault is remedied.

After power and communications distribution module 615 receives fault-managed power 610, power and communications distribution module 615 can transmit Class 1 or 2 power 620-1, 620-2, 620-3, and 620-4 to DSM 625, DSD 626, sensor(s) 627, and actuator(s) 628, respectively. Based on the coupled device and an amount of power required to drive the coupled device, power and communications distribution module 615 can convert fault-managed power 610 to an appropriate power for the coupled device. In some examples, power and communications distribution module 615 may include one or more power converters for each coupled device. By way of example, sensor(s) 627 may use DC power (power 620-3), while DSD 626 may use AC power (power 620-2), so power and communications distribution module 615 may include a DC-to-DC power converter to convert fault-managed power 610 to a DC power for use by sensor(s) 627 and a DC-to-AC power converter to convert fault-managed power 610 to an AC power for use by DSD 626. Any combination or variation may be contemplated.

Power and communications distribution module 615 may further provide communications 621-1, 621-2, 621-3, and 621-4 to each of DSM 625, DSD 626, sensor(s) 627, and actuator(s) 628, respectively, individually with respect to power 620-1, 620-2, 620-3, and 620-4. For example, power and communications distribution module 615 may be coupled with DSM 625, DSD 626, sensor(s) 627, and actuator(s) 628 via standard Ethernet cabling, or other low-voltage networking cabling, to communicate with each device.

Examples of the coupled devices include DSM 625, DSD 626, sensor(s) 627, and actuator(s) 628, however, power and communications distribution module 615 may drive other devices or systems not shown. DSM 625 is representative of a distributed drive that interfaces directly with a motor to control operation thereof. DSD 626 is representative of a distributed drive that may couple with an external motor to control operation thereof. Sensor(s) 627 may include any number of sensors operable in an industrial, commercial, or industrial automation environment, such as voltage or current sensors, temperature sensors, motion sensors, image sensors, and the like. Actuator(s) 628 are representative of one or more components capable of moving or controlling devices or systems in an industrial, commercial, or industrial automation environment.

Each of the coupled devices of block diagram 500 may be individually coupled to and driven by power and communications distribution module 615. In various examples, power and communications distribution module 615 is coupled to each of the devices by a transmission line capable of transferring Class 1 or Class 2 power along the transmission line. Thus, the connections between DSM 625, DSD 626, sensor(s) 627, and actuator(s) 628 and power and communications distribution module 615 may not be made using SPE.

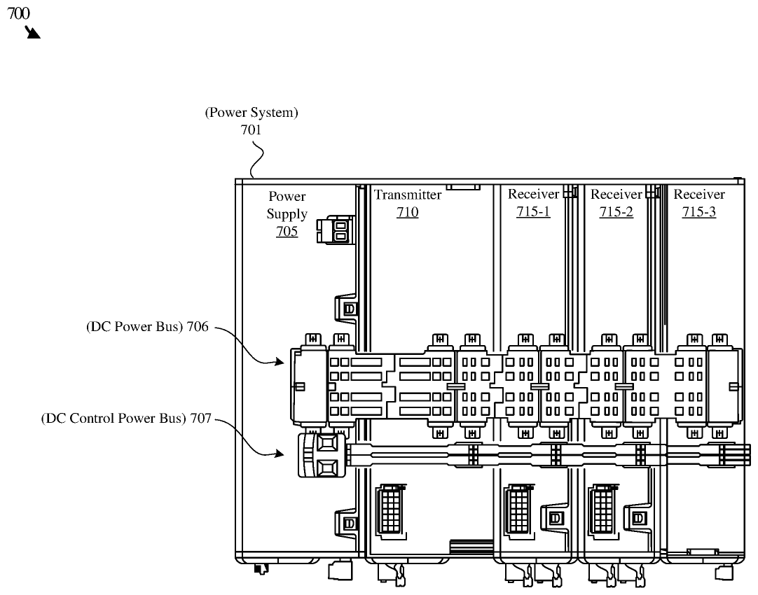

FIG. 7 illustrates an example operating environment in accordance with some embodiments of the present technology. FIG. 7 includes operating environment 700, which includes power system 701 and components thereof. Power system 701 may include power supply 705, transmitter 710, receivers 715-1, 715-2, and 715-3 (collectively receivers 715), DC power bus 706, and DC control power bus 707. Components of power system 701 may perform power conversion, fault-managed power transmission, and communications transmission processes, such as process 800 of FIG. 8.

Power system 701 is representative of a power drive and power distribution system operable in an industrial, commercial, or industrial automation environment, among other environments (e.g., a Kinetix 5700 Drive). In reference to operating environment 101 of FIG. 1A, components of power system 701 may represent one or more of bus power source 106, FMP transmitter 110, FMP receivers 115, and circuitry thereof.

Power supply 705 is representative of a device capable of receiving power from a main power supply (e.g., main power source 105) and providing a converted power to other devices in power system 701. For example, power supply 705 may be representative of bus power source 106 of FIG. 1A. Power supply 705 may receive power from an external power source (not shown) and convert the main power provided by the external power source into fault-managed powers.

Power supply 705 includes DC power bus 706 and DC control power bus 707. DC power bus 706 may be a bus device that can provide DC power to transmitter 710 and receivers 715. DC control power bus 707 may be a different bus device that can provide DC control power to transmitter 710 and receivers 715. In various examples, the DC control power has a lower voltage than the DC power and may be used in cases where DC power bus 706 is turned off or faulty, or to power up and initialize transmitter 710 and receivers 715.

Transmitter 710 may represent a transmitter device, apparatus, or circuitry included in power system 701 to interface with receivers 715 and provide fault-managed control power to receivers 715 via DC control power bus 707 (e.g., a single-axis inverter, a dual-axis inverter, a PIM). In various examples, transmitter 705 may be representative of bus power source 106 of FIG. 1A, FMP transmitter 110 of FIG. 1A, FMP transmitter 110 of FIG. 2, FMP transmitter 110 of FIG. 4, and include circuitry and other components described above. In some examples, transmitter 710 may further generate and provide fault-managed power based on the DC power provided by power supply 705 via DC power bus 706, such as fault-managed power to drive operations of receivers 715.

Receivers 715 may represent receiver devices, apparatuses, or circuitry included in power system 701 that can drive loads (e.g., distributed drives, motors, sensors, actuators) using the fault-managed power provided by transmitter 710 via DC control power bus 707. In various examples, receivers 710 may be representative of and include components of FMP receivers 115 of FIG. 1A, FMP receiver 115 of FIG. 2, FMP receivers 115 of FIG. 3, and include circuitry and other components described above.

Transmitter 710 and receivers 715 may be coupled together via DC power bus 706 and DC control power bus 707. Both DC power bus 706 and DC control power bus 707 may be coupled to each of transmitter 710, receiver 715-1, receiver 715-2, and receiver 715-3, such as in a multi-drop topology, via wires (e.g., SPE 112 of FIG. 1A). More specifically, DC power bus 706 and DC control power bus 707 may include hardware components that may be physically coupled to portions of transmitter 710 and receivers 715.

In operation, transmitter 710 may receive a DC power from power supply 705 via DC power bus 706 and a DC control power from power supply 705 via DC control power bus 707. Transmitter 710 can use the DC control power to generate a fault-managed control power. Transmitter 710 can provide the fault-managed control power to receivers 715-1, 715-2, and 715-3 via connections of DC control power bus 707, such as via SPE cabling. Transmitter 710 may also establish a communication channel with receivers 715 via the same SPE cabling. Receivers 715 can determine how much fault-managed control power each may consume during operations and provide measurements of the received fault-managed control power and the estimated control power consumption to transmitter 710. Based on the measurements and the estimated control power consumption, transmitter 710 may detect a fault somewhere along DC control power bus 707 or at one of receivers 715. In the absence of a fault, transmitter 710 can continue to provide the power through DC control power bus 707.

In some examples, transmitter 710 may further provide the fault-managed control power to other devices (not shown), such as servo motors, actuators, or other industrial or industrial automation devices. Transmitter 710 may be coupled with such other devices via SPE cabling in any variety of topologies or wiring schemes.

In other examples, transmitter 710 may also generate a fault-managed main power based on the DC power provided by power supply 705 via DC power bus 706. Like the control power, transmitter 710 can transmit the fault-managed main power to receivers 715, and possible other devices not shown, via SPE cabling across DC power bus 706. Transmitter 710 can further establish a communication channel using the SPE cabling for detection of faults in the fault-managed main power.

In traditional systems, the DC control power may be limited to 24 V. In such systems, start-up operations and processes operable by receivers 715 may be limited based on the amount of control power available. Advantageously, however, in various examples such as ones described above, transmitter 710 may generate a fault-managed control power, which may have a higher voltage of approximately 400 V. Therefore, in examples where transmitter 710 provides a higher voltage fault-managed control power, relative to traditional control power, receivers 715 may be less limited with respect to operations and power conversation techniques, and further, may be coupled to transmitter 710 using low-voltage cabling as opposed to robust cabling.

FIG. 8 illustrates a series of steps for detecting faults within a fault-managed power system in accordance with some embodiments of the present technology. FIG. 8 includes process 800, which references elements of operating environment 101 of FIG. 1A. In various examples, process 800 may be implemented in hardware, software, firmware, or any combination or variation. For example, process 800 may be implemented in circuitry 107 of bus power source 106, circuitry 111 of FMP transmitter 110, and/or circuitry 116 of FMP receivers 115.

In operation 805, FMP transmitter 110 receives power from main power source 105 or bus power source 106. Main power source 105 is representative of any alternating current (AC) or direct current (DC) power source. For example, main power source 105 may be AC mains electricity or a DC source, such as a rectifier or fuel cell. In some examples, main power source 105 may produce power categorized under Class 1 power of the NEC. Main power source 105 may be coupled to FMP transmitter 110, or circuitry 111 of FMP transmitter 110, to provide power to FMP transmitter 110. In other examples, FMP transmitter 110 receives power from main power source 105 via bus power source 106. In other words, bus power source 106 may be configured to receive power from main power source 105, convert the power into a DC power, and provide DC power to FMP transmitter 110.

FMP transmitter 110 is representative of a device, apparatus, or circuitry capable of receiving power from main power source 105 or bus power source 106, converting the power into fault-managed power, and transmitting the fault-managed power to FMP receivers 115 over a transmission link or line (SPE 112).

In operation 810, FMP transmitter 110 establishes a continuous communication channel with FMP receivers 115 using SPE 112. FMP receivers 115 are representative of devices, apparatuses, or circuitry capable of receiving power from FMP transmitter 110, converting the power into power usable by drives 117, and determining an expected power consumption by the drives 117. In some embodiments, FMP receivers 115 may be arranged in a multi-drop topology with respect to FMP transmitter 110. In other embodiments, FMP receivers 115 may be arranged in a linear topology with respect to FMP transmitter 110, a star topology with respect to FMP transmitter 110, or a ring topology. The continuous communication channel may be used to exchange data signals between FMP transmitter 110 and FMP receivers 115, such as the expected power consumption identified by FMP receivers 115. Communications and data between FMP transmitter 110 and FMP receivers 115 can transmit directly over the fault-managed power continuously, allowing FMP transmitter 110 to determine whether a fault has occurred at any point during transmission and reception of the fault-managed power.

Prior to generating fault-managed power, in operation 815, FMP transmitter 110 performs a start-up sequence to initialize circuitry of FMP transmitter 110 (e.g., circuitry 111) and FMP receivers 115 (e.g., circuitry 116). The start-up sequence may begin when the input power is provided to FMP transmitter 110. A control AC-to-DC power converter (e.g., power converter 213 of FIG. 2), a low-voltage power converter (e.g., low-voltage isolated converter 224), and a microcontroller of FMP transmitter 110 (e.g., microcontroller 214) may turn on, and an FMP AC-to-DC power converter (e.g., FMP converter 219) may be disabled. The low-voltage power converter can transmit low-voltage DC power over single-pair Ethernet cable (SPE) (e.g., SPE 112, transmission line 226) to FMP receiver 115. SPE may include a single pair of conductors (i.e., wires) that connect FMP transmitter 110 to FMP receiver 115. The low-voltage power passes through an over-voltage switch (e.g., over-voltage switch 240) in FMP receiver 115 causing a control DC-to-DC converter (e.g., power converter 243) in FMP receiver 115 to turn on. Next, a microcontroller in FMP receiver 115 turns on (e.g., microcontroller 235).

After low-voltage signals are flowing through both FMP transmitter 110 and FMP receiver 115, the microcontroller of FMP transmitter 110 measures the voltage and current flowing through wires of FMP transmitter 110. If the microcontroller determines that the voltage and current are above threshold values, the microcontroller can disable the control AC-to-DC power converter and the low-voltage power converter to prevent damage to either FMP transmitter 110 or FMP receiver 115. The microcontroller may wait an amount of time, then attempt to begin the start-up sequence again. If the microcontroller determines that the voltage and current are within threshold values, the microcontroller can establish a communication channel between FMP transmitter 110 and FMP receiver 115 via SPE physical layers (PHYs) (e.g., SPE PHYs 215 and 234). The communication channel may form a black channel by which FMP transmitter 110 and FMP receiver 115 can communicate in accordance with a safety protocol (e.g., CIP). At this time, the microcontroller of FMP receiver 115 can measure the line voltage and current flowing through components of FMP receiver 115 and safety communicate these measurements to FMP transmitter 115 via the SPE. The microcontroller of FMP transmitter 110 can compare the measurements from FMP receiver 115 to threshold values and determine whether there is a fault at FMP receiver 115. If so, FMP transmitter 110 can stop transmission of the low-voltage DC power to FMP receiver 115. If not, FMP transmitter 110 can enable the FMP AC-to-DC converter to begin generating the FMP.

In operation 820, FMP transmitter 110 generates a fault-managed power based on the power from main power source 105 or bus power source 106. FMP transmitter 110 includes circuitry 111, representative of various electronic and electro-mechanical elements capable of interfacing with main power source 105, to convert the power from main power source 105 to DC power or to AC power and generate fault-managed power from the DC or AC power. In various examples, circuitry 111 may include a microcontroller, one or more power converters, transformers, diodes, resistors, capacitors, and the like. The microcontroller may include one or more processors or processing units capable of communicating with FMP receivers 115, transmitting data and power to FMP receivers 115, and detecting a fault within FMP transmitter 110 or FMP receivers 115 during transmission of the fault-managed power. Examples of such processor(s) may include microcontrollers, DSPs, general purpose central processing units, application specific processors or circuits (e.g., ASICs), and logic devices (e.g., FPGAs), as well as any other type of processing device, combinations, or variations thereof.

In operation 825, FMP transmitter 110 transmits, via a transmission link formed using SPE 112, an unpulsed signal including the fault-managed power to FMP receivers 115. SPE 112 may include a pair of conductors (i.e., wires). The pair of conductors may be used to transmit the fault-managed power from FMP transmitter 110 to FMP receivers 115 and exchange communications between FMP transmitter 110 and FMP receivers 115. In various examples, FMP transmitter 110 provides the fault-managed power to FMP receivers 115 over SPE 112 as an unpulsed signal. In other words, FMP transmitter 110 generates a signal having a duty cycle of 100%. However, other duty cycles may be contemplated.

To measure the amount of fault-managed power received and the amount of power to be consumed by drives 117, FMP receivers 115 may include circuitry 116. Circuitry 116 is representative of various electronic and electro-mechanical elements capable of interfacing with drives 117, converting the fault-managed power to power appropriate for each of drives 117, and communicating expected power consumption by drives 117 to FMP transmitter 110. In various examples, circuitry 116 may include a microcontroller, one or more power converters, transformers, diodes, resistors, capacitors, and the like. The microcontroller may include one or more processors or processing units capable of communicating with FMP transmitter 110 and transmitting data to FMP transmitter 110 during transmission of the fault-managed power. Examples of such processor(s) may include microcontrollers, DSPs, general purpose central processing units, application specific processors or circuits (e.g., ASICs), and logic devices (e.g., FPGAs), as well as any other type of processing device, combinations, or variations thereof.

In operation 830, FMP transmitter 110 receives an indication of power consumption from FMP receivers 115 over the continuous communication channel via SPE 112. FMP transmitter 110 can compare measurements of the fault-managed power sensed by circuitry 111 with measurements sensed by circuitry 116 of FMP receivers 115. In operation 835, FMP transmitter 110 can detect a fault based on this comparison. In some examples, FMP transmitter 110 uses pre-determined threshold values in its comparison. However, in other examples, FMP transmitter 110 can dynamically determine threshold values based on fluctuations in power consumption by drives 117, for instance.

Following detection of a fault, such as a line-to-line or line-to-ground fault, FMP transmitter 110, in operation 840, terminates transmission of the fault-managed power to FMP receivers 115, such that FMP receivers 115 and drives 117 coupled to FMP receivers 115 no longer receive the fault-managed power until FMP transmitter 110 initiates transmission again. In some cases, FMP transmitter 110 waits a pre-determined amount of time before re-transmitting. In other cases, FMP transmitter 110 may re-transmit the fault-managed power after a user manually resets FMP transmitter 110 and/or FMP receivers 115. However, prior to re-transmitting the fault-managed power, FMP transmitter 110 may perform the start-up sequence again as in operation 815, then proceed to perform subsequent operations of process 800. If no fault is detected at any point, FMP transmitter 110 may continuously provide fault-managed power to FMP receivers 115. This may entail generating new instances of the fault-managed power, as in operation 820, and continuing to monitor for faults while repeatedly performing operations 825 and 830.

Process 800 may similarly be applied to fault-managed control power and communications established between bus power source 106 and FMP transmitter 110. In such examples, bus power source 106 includes circuitry 107 that functions like a fault-managed power transmitter (e.g., FMP transmitter 110 of FIG. 2), and FMP transmitter 110 includes circuitry 111 that functions both like a fault-managed power transmitter and receiver (e.g., FMP receiver 115 of FIG. 2). Bus power source 106 can generate a fault-managed control power and provide the fault-managed control power to FMP transmitter 110 over SPE 108. Bus power source 106 can further establish a different continuous communication channel with FMP transmitter 110. FMP transmitter 110 can provide an indication of expected control power consumption to bus power source 106 and can power elements of FMP transmitter 110 using the fault-managed control power. Bus power source 106 can compare the expected control power consumption and the fault-managed control power to threshold values to identify whether there is a fault in either bus power source 106 or FMP transmitter 110.

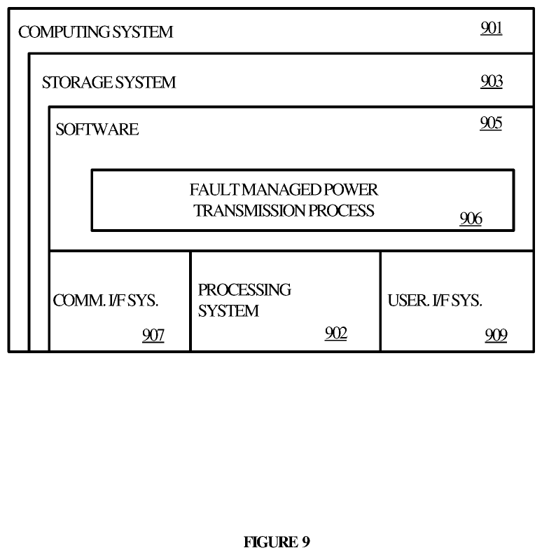

FIG. 9 illustrates computing system 901 to perform fault-managed power (FMP) generation and transmission according to an implementation of the present technology. Computing system 901 is representative of any system or collection of systems with which the various operational architectures, processes, scenarios, and sequences disclosed herein for device health collection and configuration may be employed. Computing system 901 may be implemented as a single apparatus, system, or device or may be implemented in a distributed manner as multiple apparatuses, systems, or devices. Computing system 901 includes, but is not limited to, processing system 902, storage system 903, software 905, communication interface system 907, and user interface system 909 (optional). Processing system 902 is operatively coupled with storage system 903, communication interface system 907, and user interface system 909. Computing system 901 may be representative of a cloud computing device, distributed computing device, or the like.

Processing system 902 loads and executes software 905 from storage system 903. Software 905 includes and implements FMP transmission process 906, which is representative of any of the fault-managed power generation, conversion, transmission, analysis, and other processes discussed with respect to the preceding Figures. When executed by processing system 902 to provide FMP functions, software 905 directs processing system 902 to operate as described herein for at least the various processes, operational scenarios, and sequences discussed in the foregoing implementations. Computing system 901 may optionally include additional devices, features, or functionality not discussed for purposes of brevity.

Referring still to FIG. 9, processing system 902 may comprise a micro-processor and other circuitry that retrieves and executes software 905 from storage system 903. Components of processing system 502 may include safety-certified features, such as 1 out of 2 (1002) architecture. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including FMP process 906) may be implemented in program instructions and among other functions may, when executed by processing system 902, direct processing system 902 to operate as described with respect to the various operational scenarios, sequences, and processes illustrated herein. For example, software 905 may include program instructions for implementing a device health metrics process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing system 901 is representative) overall from a general-purpose computing system into a special-purpose computing system customized to provide device health metrics and contextualization and instantiation thereof as described herein. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

Example embodiments of the present disclosure are summarized here. Other embodiments can also be understood from the entirety of the specification and the claims filed herein.

Example 1. A fault-managed power system, comprising: a first power supply configured to generate a first power; a second power supply coupled to receive the first power from the first power supply and comprising bus transmitter circuitry configured to: generate a fault-managed control power based on the first power; and transmit the fault-managed control power to a power interface module via a first transmission link formed using a first single-pair Ethernet cable; the power interface module coupled to receive the first power from the first power supply and comprising: module receiver circuitry configured to receive the fault-managed control power from the second power supply; and module transmitter circuitry configured to: generate a fault-managed power based on the first power from the first power supply; transmit an unpulsed signal comprising the fault-managed power to drive receiver circuitry via a second transmission link formed using a second single-pair Ethernet cable; establish a continuous communication channel with the drive receiver circuitry using the second single-pair Ethernet cable for exchanging data signals; receive an indication of load power consumption from the drive receiver circuitry via the continuous communication channel; detect a fault based on a comparison between the transmitted fault-managed power and the load power consumption; and terminate, in response to detecting the fault, transmission of the fault-managed power to the drive receiver circuitry; and the drive receiver circuitry, wherein the drive receiver circuitry is coupled to the module transmitter circuitry via the second single-pair Ethernet cable and to two or more distributed drives in an industrial automation environment, and wherein each of the two or more distributed drives is configured to drive a respective motor using the fault-managed power.

Example 2. The fault-managed power system of example 1, wherein the bus transmitter circuitry is further configured to: establish a further continuous communication channel with the module receiver circuitry of the power interface module using the first single-pair Ethernet cable for exchanging bus data signals; receive an indication of control power consumption from the module receiver circuitry via the further continuous communication channel; detect a control power fault based on a comparison between the transmitted fault-managed control power and the control power consumption; and terminate, in response to detecting the control power fault, transmission of the fault-managed control power to the module receiver circuitry.

Example 3. The fault-managed power system of one of examples 1 or 2, wherein the module transmitter circuitry is further configured to: transmit a further unpulsed signal comprising the fault-managed control power to the drive receiver circuitry via the second transmission link; receive an indication of control power consumption from the drive receiver circuitry via the continuous communication channel; detect a control power fault based on a comparison between the transmitted fault-managed control power and the control power consumption; and terminate, in response to detecting the control power fault, transmission of the fault-managed control power to the drive receiver circuitry.

Example 4. The fault-managed power system of one of examples 1 to 3, wherein to drive the respective motor using the fault-managed power, each of the the distributed drives is configured to generate a three-phase AC power based on the fault-managed power.

Example 5. The fault-managed power system of one of examples 1 to 4, wherein the drive receiver circuitry comprises two or more drive receiver circuits, wherein each of the two or more drive receiver circuits is configured to measure current of the respective motor driven by the fault-managed power, and wherein the load power consumption is determined based on the measured current.

Example 6. The fault-managed power system of one of examples 1 to 5, wherein the module transmitter circuitry comprises a transmitter physical layer, wherein the drive receiver circuitry comprises two or more receiver physical layers, and wherein the continuous communication channel is established between the transmitter physical layer and the receiver physical layers.

Example 7. The fault-managed power system of one of examples 1 to 6, wherein the data signals are exchanged via the continuous communication channel in accordance with a safety protocol, and wherein the safety protocol is one of a common industrial protocol (CIP) and a black-channel safety protocol.

Example 8. The fault-managed power system of one of examples 1 to 7, wherein the drive receiver circuitry is configured to provide the load power consumption via the continuous communication channel with a packet transmission speed in accordance with the safety protocol.

Example 9. The fault-managed power system of one of examples 1 to 8, wherein the module transmitter circuitry is further configured to detect the fault based on a delay in receiving the indication of the load power consumption from the drive receiver circuitry beyond a threshold time.

Example 10. The fault-managed power system of one of examples 1 to 9, wherein the fault-managed power and the fault-managed control power are Class 4 power.

Example 11. The fault-managed power system of one of examples 1 to 10, wherein the detected fault is one of a line-to-line fault and a line-to-ground fault.

Example 12. The fault-managed power system of one of examples 1 to 11, wherein the first power includes either alternating-current (AC) power or direct current (DC) power, and wherein the second power is a DC power.

Example 13. The fault-managed power system of one of examples 1 to 12, wherein the drive receiver circuitry comprises two or more drive receiver circuits arranged in one of a multi-drop configuration, a linear configuration, or a star configuration with respect to the power interface module.

Example 14. The fault-managed power system of one of examples 1 to 13, wherein a drive receiver circuit of the two or more receiver circuits is coupled with a terminator at an end of the second transmission link opposite the power interface module.

Example 15. The fault-managed power system of one of examples 1 to 14, wherein each of the two or more drive receiver circuits comprises converter circuitry configured to convert the fault-managed power into a motor power and an interface configured to provide the motor power to the respective motor associated with the drive receiver circuit.

Example 16. A fault-managed power system, comprising: a transmitter circuit coupled to receive power from a power source and configured to: generate a fault-managed power based on the power from the power source; transmit an unpulsed signal comprising the fault-managed power to two or more receiver circuits via a transmission link formed using a single-pair Ethernet cable; establish a continuous communication channel with the two or more receiver circuits using the single-pair Ethernet cable for exchanging data signals; receive an indication of power consumption from the two or more receiver circuits via the continuous communication channel; detect a fault based on a comparison between the transmitted fault-managed power and the power consumption; and terminate, in response to detecting the fault, transmission of the fault-managed power to the one or more receiver circuits; and the two or more receiver circuits, wherein each of the two or more receiver circuits is coupled to the transmitter circuitry via the single-pair Ethernet cable and to a distributed drive in an industrial automation environment, and wherein each of the distributed drives is configured to drive a respective motor using the fault-managed power.

Example 17. The fault-managed power system of example 16, wherein to drive the respective motor using the fault-managed power, each of the the distributed drives is configured to generate a three-phase AC power based on the fault-managed power.

Example 18. The fault-managed power system of example 16 or 17, wherein the distributed drives are distributed servo-drives, distributed servo-motors, or a combination thereof.

Example 19. The fault-managed power system of one of examples 16 to 18, wherein each of the distributed drives comprises converter circuitry configured to convert the fault-managed power into a motor power and an interface configured to provide the motor power to the respective motor associated with the distributed drive.

Example 20. The fault-managed power system of one of examples 16 to 19, wherein the transmitter circuit comprises a transmitter physical layer and each of the two or more receiver circuits comprises a receiver physical layer, and wherein the continuous communication channel is established between the transmitter physical layer and the receiver physical layers.

Example 21. The fault-managed power system of one of examples 16 to 20, wherein the data signals are exchanged via the continuous communication channel in accordance with a safety protocol, and wherein the safety protocol is one of a common industrial protocol (CIP) and a black-channel safety protocol.

Example 22. The fault-managed power system of one of examples 16 to 21, wherein each of the one or more receiver circuits is configured to provide the power consumption via the continuous communication channel with a packet transmission speed in accordance with the safety protocol.

Example 23. The fault-managed power system of one of examples 16 to 22, wherein the transmitter circuit is further configured to detect the fault based on a delay in receiving the indication of the power consumption from the two or more receiver circuits beyond a threshold time.

Example 24. The fault-managed power system of one of examples 16 to 23, wherein the fault-managed power is Class 4 power.

Example 25. The fault-managed power system of one of examples 16 to 24, wherein the detected fault is one of a line-to-line fault and a line-to-ground fault.

Example 26. The fault-managed power system of one of examples 16 to 25, wherein the power includes either alternating-current (AC) power or direct current (DC) power.

Example 27. The fault-managed power system of one of examples 16 to 26, wherein the two or more receiver circuits are arranged in one of a multi-drop configuration, a linear configuration, or a star configuration with respect to the transmitter circuit.

Example 28. The fault-managed power system of one of examples 16 to 27, wherein a receiver circuit of the two or more receiver circuits is coupled with a terminator at an end of the transmission link opposite the transmitter circuit.

Example 29. A fault-managed power system, comprising: a first power supply configured to generate a first power; a second power supply coupled to receive the first power from the first power supply and comprising transmitter circuitry configured to: generate a fault-managed control power based on the first power; transmit the fault-managed control power to a power interface module via a transmission link formed using a single-pair Ethernet cable; establish a continuous communication channel with receiver circuitry of the power interface module using the single-pair Ethernet cable for exchanging data signals; receive an indication of control power consumption from the receiver circuitry via the continuous communication channel; detect a fault based on a comparison between the transmitted fault-managed control power and the control power consumption; and terminate, in response to detecting the fault, transmission of the fault-managed control power to the receiver circuitry; and the power interface module coupled to receive the first power from the first power supply and comprising the receiver circuitry configured to receive the fault-managed control power from the second power supply.

Example 30. The fault-managed power system of example 29, wherein the power interface module further comprises module transmitter circuitry configured to: transmit an unpulsed signal comprising the fault-managed control power to drive receiver circuitry via a second transmission link formed using a second single-pair Ethernet cable; receive an indication of load power consumption from the drive receiver circuitry; detect a control power fault based on a comparison between the transmitted fault-managed control power and the control power consumption; and terminate, in response to detecting the control power fault, transmission of the fault-managed control power to the drive receiver circuitry.

Example 31. The fault-managed power system of example 29 or 30, further comprising the drive receiver circuitry, wherein the drive receiver circuitry comprises two or more drive receiver circuits, and wherein each of the two or more drive receiver circuits is coupled to the module transmitter circuitry via the second transmission link and coupled to a motor via a drive interface.

Example 32. The fault-managed power system of one of examples 29 to 31, wherein each of the two or more drive receivers is configured to initialize a respective motor using the fault-managed control power.

Example 33. The fault-managed power system of one of examples 29 to 32, wherein each of the two or more drive receivers is a distributed servo-drive, a distributed servo-motor, or a combination thereof.

Example 34. The fault-managed power system of one of examples 29 to 33, wherein the fault-managed control power is a Class 4 DC control power.

Example 35. The fault-managed power system of one of examples 29 to 34, wherein the first power includes either alternating-current (AC) power or direct current (DC) power.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in cither this application or in a continuing application.

What is claimed is:

1. A fault-managed power system, comprising:
a first power supply configured to generate a first power;
a second power supply coupled to receive the first power from the first power supply and comprising bus transmitter circuitry configured to:
generate a fault-managed control power based on the first power; and
transmit the fault-managed control power to a power interface module via a first transmission link formed using a first single-pair Ethernet cable;
the power interface module coupled to receive the first power from the first power supply and comprising:
module receiver circuitry configured to receive the fault-managed control power from the second power supply; and
module transmitter circuitry configured to:
generate a fault-managed power based on the first power from the first power supply;
transmit an unpulsed signal comprising the fault-managed power to drive receiver circuitry via a second transmission link formed using a second single-pair Ethernet cable;
establish a continuous communication channel with the drive receiver circuitry using the second single-pair Ethernet cable for exchanging data signals;
receive an indication of load power consumption from the drive receiver circuitry via the continuous communication channel;
detect a fault based on a comparison between the transmitted fault-managed power and the load power consumption; and
terminate, in response to detecting the fault, transmission of the fault-managed power to the drive receiver circuitry; and
the drive receiver circuitry, wherein the drive receiver circuitry is coupled to the module transmitter circuitry via the second single-pair Ethernet cable and to two or more distributed drives in an industrial automation environment, and wherein each of the two or more distributed drives is configured to drive a respective motor using the fault-managed power.

2. The fault-managed power system of claim 1, wherein the bus transmitter circuitry is further configured to:
establish a further continuous communication channel with the module receiver circuitry of the power interface module using the first single-pair Ethernet cable for exchanging bus data signals;
receive an indication of control power consumption from the module receiver circuitry via the further continuous communication channel;
detect a control power fault based on a comparison between the transmitted fault-managed control power and the control power consumption; and
terminate, in response to detecting the control power fault, transmission of the fault-managed control power to the module receiver circuitry.

3. The fault-managed power system of claim 1, wherein the module transmitter circuitry is further configured to:
transmit a further unpulsed signal comprising the fault-managed control power to the drive receiver circuitry via the second transmission link;
receive an indication of control power consumption from the drive receiver circuitry via the continuous communication channel;
detect a control power fault based on a comparison between the transmitted fault-managed control power and the control power consumption; and
terminate, in response to detecting the control power fault, transmission of the fault-managed control power to the drive receiver circuitry.

4. The fault-managed power system of claim 1, wherein to drive the respective motor using the fault-managed power, each of the the distributed drives is configured to generate a three-phase AC power based on the fault-managed power.

5. The fault-managed power system of claim 1, wherein the drive receiver circuitry comprises two or more drive receiver circuits, wherein each of the two or more drive receiver circuits is configured to measure current of the respective motor driven by the fault-managed power, and wherein the load power consumption is determined based on the measured current.

6. The fault-managed power system of claim 1, wherein the module transmitter circuitry comprises a transmitter physical layer, wherein the drive receiver circuitry comprises two or more receiver physical layers, and wherein the continuous communication channel is established between the transmitter physical layer and the receiver physical layers.

7. The fault-managed power system of claim 1, wherein the data signals are exchanged via the continuous communication channel in accordance with a safety protocol, and wherein the safety protocol is one of a common industrial protocol (CIP) and a black-channel safety protocol.

8. The fault-managed power system of claim 7, wherein the drive receiver circuitry is configured to provide the load power consumption via the continuous communication channel with a packet transmission speed in accordance with the safety protocol.

9. The fault-managed power system of claim 1, wherein the module transmitter circuitry is further configured to detect the fault based on a delay in receiving the indication of the load power consumption from the drive receiver circuitry beyond a threshold time.

10. The fault-managed power system of claim 1, wherein the fault-managed power and the fault-managed control power are Class 4 power.

11. The fault-managed power system of claim 1, wherein the detected fault is one of a line-to-line fault and a line-to-ground fault.

12. The fault-managed power system of claim 1, wherein the first power includes either alternating-current (AC) power or direct current (DC) power, and wherein the second power is a DC power.

13. The fault-managed power system of claim 1, wherein the drive receiver circuitry comprises two or more drive receiver circuits arranged in one of a multi-drop configuration, a linear configuration, or a star configuration with respect to the power interface module.

14. The fault-managed power system of claim 13, wherein a drive receiver circuit of the two or more receiver circuits is coupled with a terminator at an end of the second transmission link opposite the power interface module.

15. The fault-managed power system of claim 3, wherein each of the two or more drive receiver circuits comprises converter circuitry configured to convert the fault-managed power into a motor power and an interface configured to provide the motor power to the respective motor associated with the drive receiver circuit.

16. A fault-managed power system, comprising:
a transmitter circuit coupled to receive power from a power source and configured to:
generate a fault-managed power based on the power from the power source;
transmit an unpulsed signal comprising the fault-managed power to two or more receiver circuits via a transmission link formed using a single-pair Ethernet cable;
establish a continuous communication channel with the two or more receiver circuits using the single-pair Ethernet cable for exchanging data signals;
receive an indication of power consumption from the two or more receiver circuits via the continuous communication channel;
detect a fault based on a comparison between the transmitted fault-managed power and the power consumption; and
terminate, in response to detecting the fault, transmission of the fault-managed power to the one or more receiver circuits; and
the two or more receiver circuits, wherein each of the two or more receiver circuits is coupled to the transmitter circuitry via the single-pair Ethernet cable and to a distributed drive in an industrial automation environment, and wherein each of the distributed drives is configured to drive a respective motor using the fault-managed power.

17. The fault-managed power system of claim 16, wherein to drive the respective motor using the fault-managed power, each of the the distributed drives is configured to generate a three-phase AC power based on the fault-managed power.

18. The fault-managed power system of claim 16, wherein the distributed drives are distributed servo-drives, distributed servo-motors, or a combination thereof.

19. The fault-managed power system of claim 16, wherein each of the distributed drives comprises converter circuitry configured to convert the fault-managed power into a motor power and an interface configured to provide the motor power to the respective motor associated with the distributed drive.

20. A fault-managed power system, comprising:
a first power supply configured to generate a first power;
a second power supply coupled to receive the first power from the first power supply and comprising transmitter circuitry configured to:
generate a fault-managed control power based on the first power;
transmit the fault-managed control power to a power interface module via a transmission link formed using a single-pair Ethernet cable;
establish a continuous communication channel with receiver circuitry of the power interface module using the single-pair Ethernet cable for exchanging data signals;
receive an indication of control power consumption from the receiver circuitry via the continuous communication channel;
detect a fault based on a comparison between the transmitted fault-managed control power and the control power consumption; and
terminate, in response to detecting the fault, transmission of the fault-managed control power to the receiver circuitry; and
the power interface module coupled to receive the first power from the first power supply and comprising the receiver circuitry configured to receive the fault-managed control power from the second power supply.
